(19) United States
(12) Patent Application Publication
(10) Pub. No.: US 2006/0233703 A1
(43) Pub. Date: Oct. 19, 2006

(54) Magnetic stimulated catalytic chemical conversion of second series elemental compounds: combination, decomposition rearrangement and/or reformation magneto chemistry

(76) Inventor: Reginald Bernard Little, Tallahassee, FL (US)

Correspondence Address: Reginald B. Little, 308 Great Lakes St, Tallahassee, FL, 32305, US

(21) Appl. No.: 11/107,698

(22) Filed: Apr. 18, 2005

(51) Int. Cl. B01J 8/02; C25B 5/00

(52) U.S. Cl. 423/659; 204/155

(57) ABSTRACT

The chemically reactive elements of the second series include Li, Be, B, C, N, O, and F. These second series elements have distinct chemistry for forming and catalyzing strong multiple bonds in competition with single bonds for challenging chemical syntheses at high rates, yields and selectivity. Their chemical reactions (associated with selective syntheses of various products of second series elements) involve high activation energies for bond breakage, bond rearrangement and bond formation steps. These activation energies are associated with energetic and momenta constraints on associated electronic orbital rehybridization and spin dynamics with nontrivial nonclassic consequences. Nonclassic discrete energies and momenta of intermediate states result in kinetic constraints due to conservation of energy and momenta during the bond rearrangement to desired products. This invention provides magnetic, laser, pressure, neutron and catalytic technology for accommodating these specific energetic and momenta requirements for the acceleration of electronic dynamics for specific chemical bond rearrangements and conversions.

Reference: This is a non-provisional application with reference to prior provisional application No. 60/488,906.

This art dedicated to Mr. Larry Thomas Chapman.

### FIELD OF THE INVENTION

The present invention involves a method and an apparatus for the massive and selective formations of singly bonded and multiply bonded compounds of the second series elements (targets). The present invention has particular applicability in selectively producing such chemical structures in high yield, purity and throughput. The invention provides a means of using external magnetic fields of intense static and dynamic durations, spatial and temporal natures to enhance the formation of these valuable saturated and unsaturated compounds. The invention also makes use of laser technology in an innovative way by (for the first time) using the laser and IR photons to rapidly heat the metal catalysts for the more efficient catalyzed activation for elemental fixation to important high spin (hybrid) second series elemental intermediary states for the stimulated, selective chemical conversions of these intermediates into massive amounts of the various singly and/or multiply bonded product compounds. The invention further exploits laser technology to drive plasmons and phonons in the catalyst for more controlled metal interactions for facile second series elemental absorption, diffusion, rehybridization, spin dynamics and/or condensation within and on the catalysts. The new art's use of laser and magnetic phenomena, to generate high densities of high spin second series elemental states and species, leads to lower pressure and temperature fabrication of single bonds in intense static magnetic fields. On the other hand, the new art's use of laser in conjunction with intense dynamic magnetic fields enhances spin density phenomena for facilitating rehybridization, spin flipping, transport and chemical conversion to intermediary spin sp² (and sp) states for multiple bond formation and interconversion. The use of external magnetization in both static and dynamic variations to both mimic, prevent and exceed inherent atomic interactions during catalytic processes, based on the here proposed art, will result in the reduction of harsh thermal chemical processes; the diminution of harsh acidic processes; and the limited requirements for harsh catalytic metal medias and dangerous high pressure systems. The new magnetic refinement will contribute to a safer, more environmentally friendly industry in accord with green chemistry. The use of new superconducting magnet technology makes these benefits practical, eliminating the power and cooling needs of DC magnets.

### BACKGROUND

Second series elemental materials and compounds thereof possess a wide variety of applications due to their unique electronic structure and chemical bonding. Within the periodic table, the second series elements involve the first row, wherein both strong effective nuclear charge and strong electronic interactions are of major significance. Current interests in these substances and materials reflect their unusual strength and toughness; their electric transport, their large thermal transport, their novel optical properties, their chemical stability, their biological significance, their energetics, and their storage capacity. Across the series, the properties range from slightly metallic to the epitome of nonmetallicity. These elements exhibit a wide range of unique chemical and physical properties. Including hydrogen, they are the major building blocks of living systems. The electronic structures contribute to unique and interesting chemical dynamics. It has been shown that these compounds of the second series provide properties ranging from high strength, low weight, stability, flexibility, good heat and electric conductivity and large surface area for a variety of applications. Individually, these materials have more excellent properties. Collectively, even more extraordinary properties are envisioned.

The industrial potential of these materials encompasses many products ranging from nanoelectronics to fuels to medicinal compounds to foods to synthetic chemicals to composite bulky strong structures to ultra-fast optical switching devices to hydrogen fuel cells to superconductors. Collectively, singly bonded and/or multiply bonded compounds of these elemental substances pose many new applications. Many of the substances of these materials have very interesting and useful nuclear, energetic, electronic, optical, physical, thermal, transport, chemical, catalytic, enzymatic, biological, structural and mechanical properties.

The best know techniques for bond rearrangement about atoms of these second elements species involve the use of lasers, electric arcs, electrochemical techniques and catalytic-thermal methods and chemical vapor deposition and physical vapor deposition systems. Traditionally these elements have been treated chemically by oxygen, fluorine or chlorine for chemical handles leading to further bond rearrangement to other compounds. The petrochemical industry makes use of carbon in variations as hydrocarbons for a foundation of the organic chemical industry. Solids and liquids have been processed by recently developed high pressure, high temperature processes with the possibility of catalytic assistance. The new art provided here introduces external magnetic forces both of static and dynamic variations in conjunction with these prior arts for more selectivity, yields and production rates of the possible useful products.

Spin effects, orbital phenomena and magnetics are important during the chemical transformations and bond rearrangement of the compounds of these elements. The important aspects of chemical reactivity and dynamics depend on resonance, bond rearrangement, structural rearrangement, atoms shifts, and/or polarizability of electron cloud, all of which involve and require dynamics of electronic orbital and spin momenta. Furthermore, these important aspects contribute to lower selectivity and a motley of chemical products. The dynamics associated with changing such momenta are more difficult for second series than other elements of the periodic table. An important example of this is the resonance of allylic cations, which reflect the efficient intramolecular interactions for pi bonding. The keto-enol tautomerism also reflects these remarkable dynamics. During such and similar phenomena, quantum mechanics and wave aspects of electrons in motion are relevant. The atomic and molecular orbitals under go alterations and changes in hybridization with associated orbital and spin transitions and mechanics. s, p, d, f, orbitals and hybrid effects may be important during such transitions of electronic states along the reaction trajectories. Unlike heavier elements, second series elements have lower densities of state, less available orbital momenta, and greater disparities in frontier orbital momenta and symmetry. These elements are more hindered in orbital dynamics for rehybridizations. Furthermore the thermodynamic stability of lower ordered hybrid states (involving pi bonding for these second series elements) leads to diminished driving forces to perpetual attempts to accelerate the higher order orbital hybrid states. These thermodynamic and kinetic factors along the reaction trajectory result in product variety and lower selectivity. Such limitations require external assistance for these elements to achieve the higher order hybrid motion. Many heavier elements can provide such assistance, via their higher densities of state, more available orbital momenta, lesser disparities in momenta and symmetries of frontier orbitals, and spin dynamics for modulating higher order hybrid bonding.

Going across the series of the periodic table from left to right, internal intra-atomic electron-electron interactions more dictate the orbital motions. Toward the left, external inter-atomic interactions can more easily change orbital motion for consequent catalytic activity of these elements. Toward the left in the table, the characteristic catalytic activity of metals is a result of their ease of changing orbital motion and their being subject to external driving forces to affect their electronic motional states and dynamics. Toward the right in the table, the nonmetals (although not generally thought of as catalysts) are better at catalyzing reactions involving resisting changes in orbital dynamics. This aspect of nonmetals contributes to their forming more chemically non-labile environments and explains their role in living organisms. Among the elements, hybrids of pdfgh can look a little like the s orbital and be catalytic a little like the s orbital and be catalyzed by the variety of s orbital motions. This aspect of the s orbital is reflected in the special catalytic properties of elements with valence s shells like hydrogen (in particular) and alkali metals toward accommodating orbital needs of second series elements to allow higher order hybrid states for higher saturation in bonding. Similar effects (but to lesser extent) of catalysis by p orbitals are expressed by alkaline earth metals (and with limitations by B and Al), which can make use of the empty p orbitals for some catalysis. The observed catalytic properties of transition metals follow from orbital phenomena associated with their s, p, d, f orbitals, hybrids thereof, proximity of needed electronic energy, and associated electronic momenta and symmetry thereof for lowering the potential energy along the reaction trajectories to select specific trajectories. According to R. B. Little, orbitals of lower azimuthal motion mimic the motion of higher azimuthal motion, thereby orbitals of lower azimuthal motion can provide possible momenta for catalytic rehybridization and the formation of more saturated bonding. The control of electron spin during such dynamics provides a key to accelerating specific reaction trajectories for desired orbital rehybridization, while decelerating orbital dynamics associated with other reaction pathways. The consequent control of electrons provides a new lever for controlling orbital dynamics and better controlling product selectivity. In this work, the external magnetic field is put forth as a new tool to affect the spin motion and organization of such orbital intermediates during chemical transformation.

It is important to consider that the conservations of energy, momenta and matter are important during bond transformations associated with chemical reactions. Both electronic orbital and spin momenta are important but until now mostly overlooked aspects of chemical dynamics, mechanics and kinetics. However Fukai and Hoffmann received the Nobel Prize in Chemistry for their work concerning orbital symmetry and the course of chemical reactions. In this art, spin dynamics is put forth as a new handle for picking orbital states, thereby controlling chemical transformation pathways. It is important to consider how different elemental atoms can gain or lose orbital and spin momenta during chemical transformations. Can an atom create its own electronic motion and spin? Are external forces, magnetic fields, photons, and/or other atoms needed to change the spins and orbital motions? If an atom such as beryllium does not have p orbital motion how can it be internally created? Or an element like sulfur having no d orbital motion, how can it be internally created? The conservation laws may answer many of these questions.

It is important to consider the conservation of energy, momenta and matter on different length and time scales. On different length and time scales, nuclear motion, electronic motion, atomic motion, molecular motion and mesoscopic motion play different roles. There is a range of time scales for exchange of nucleonic motion, electronic motion, nuclear motion, atomic motion, molecular motion and mesoscopic motion. Quantum mechanical uncertainty for shorter time scales can contribute tunneling effects associated with momentary violation of the conservation laws and over small spatial or momenta ranges; and over small energy or temporal ranges. In some special cases, relativity and space-time effects may be important, involving spatial contraction and time dilation. Also the relativistic effects of mass-energy phenomena (involving energy to mass or mass to energy conversion) may be important. If time is short enough, then the uncertainty of energy can lead to important chemical effects along reaction trajectories. If the space is small enough, then the uncertainty of momenta can play important roles. Relativistic effects only occur as electrons approach speed of light for time dilation and length contraction and in massive atoms electrons may exhibit possible mass-energy effects. Upon closer consideration, these effects may play important roles in the chemical dynamics of some systems that deserve more attention.

Nucleonic motion occurs at higher frequency over smaller distance than other motions of atoms. But the motion of the nucleus occurs over larger space and at lower frequency than its internal nucleonic constituents. Electronic motion (other than its spin) occurs at even lower frequency and over larger distance relative to motion of nucleons. Atomic motion occurs at even smaller frequency and over larger space than electronic motion. It is important to consider the coupling of these motions and there relevance to chemical reactions. Spin motions of electrons and the nucleons certainly couple and have been demonstrated to affect chemical reactions (Turro and Buchachenko). Orbital motion of nucleons is much faster than that of electrons in atoms. Nucleons cannot give electrons there motion unless electrons go into the nucleus and form neutrons or vice versa, for neutron decay. Neutronic formation may occur by excited nuclei giving electrons momenta. Cosmic rays or neutrinos can excite nuclei to absorb electrons to combine with proton, and to form neutrons. Neutrons can decay to protons plus electrons with neutrinos. The resulting electrons then come out of the nuclei and they must give the protons and neutrinos motion. During transformations of the electrons from the nuclei, it important to note the handedness of this process according to the work resulting in Nobel prize in Physics by Chen Ning Yang and Tsung-Dao Lee. In a magnetic field, the mechanics and dynamics of such a beta process results in the electrons leaving with specific momenta. Nucleons can change their motion by neutrinos. Electrons can change their motion by photons. Photons can affect other electrons on other atoms. Nucleons can affect other nucleons via neutrinos. So atoms can communicate via photons and nucleons can communicate by neutrinos, so the sun can communicate with matter on earth via photons and neutrinos.

So time and space are crucial during these dynamics. The transformations need short time and small space so that uncertainty may allow tunneling. The momenta of nucleons and electrons are conserved. For unconservatory tunneling processes events involve very short time and spatial scales. Even after tunneling, the overall momenta are conserved. Momenta may be exchanged by photons, electrons, protons, neutrons and other atoms. R. B. Little first suggests the use of neutrons to affect chemical dynamics based on the external neutrons modulating the momenta of nuclei, electrons and their spins to accelerate and to select chemical dynamics. In this art, R. B. Little exploits the momental aspects of electronic motion (both orbital and spin) to effect chemical dynamics of second series elements by use of external magnetic technology. Therefore as put forth in this new art, the orbital aspects of chemical reactions may be controlled by spin effects. Many of these effects are revealed intrinsically in the catalytic properties of hydrogen, alkali metals and transition metals. So spin effects can prevents orbital bonding, allowing instead further orbital dynamics of rehybridization for different products. In essence, this new art imposes external magnetism to control electronic spin thereby modulating atomic interactions for effecting orbital rehybridizations for desirable bonding and structures of the second series elements. Next the inherent aspects of orbital and spin dynamics of elements from hydrogen to fluorine in the periodic table are considered in conjunction with some of their chemical and physical properties. On the basis of this established orbital and spin momental dynamics, the use of external magnetism to influence and control chemical and catalytic properties of these elements is demonstrated.

Hydrogen

Hydrogen is the most unique element. Consisting only of a nucleus and an electron of the 1s orbital, hydrogen has no core electron. Its valence electron interacts strongly and uniquely with its nucleus. This work introduces that such character of hydrogen results in novel and anomalous effects in the chemistry of hydrogen and the catalysis by hydrogen. R. B. Little has used these unique aspects of the electronic structure of hydrogen and its special orbital and spin dynamics to explain anomalous cold fusion phenomena. Thereby this hydrogenous character explains many of the physicochemical properties of hydrogen. Hydrogen with its one electron can do all that the other elements can do, in addition it can do what the other elements can not do. Other elements are more restricted in valence electronic motion than hydrogen. Hydrogen being more unlimited can provide orbital motion to other elements, thereby catalyzing reactions. Hydrogen thereby catalyzes reactions of other elements. Hydrogen and the proton state exhibit the acid catalytic effects throughout chemistry. In this new art, many of these special chemical and catalytic properties are explained to result from unique hydrogenous spin and orbital dynamics facilitated by the electron in the is orbital and its proximity to the proton of nucleus. These aspects of hydrogen contribute to its importance as aqueous and protic solvents to many reactions. Hydrogen bonding and Bronsted Lowery acid-base properties (H⁺ and OH⁻) follow directly from these aspects. The Lewis acid-base properties also follow from the unrestricted orbital nature of the Is orbital and the proton's ready accepting an electron pair of the OH⁻. The electron pairs go readily into and out of is of protons with no orbital or spin restrictions. These are special motional aspects of the 1s orbital and only hydrogen has vacancy in 1s orbital for the chemical exploitation of this unique electronics. Hydrogen is unique with no core electrons. The 1s orbital can thereby take on patterns of orbital momenta of any subshell of any other element. But other higher order azimuthal motions cannot take on s orbital motion. The s orbital motion of H—H (in addition to bond strength) contributes to the high bond dissociation temperature of molecular hydrogen. What other element can completely mimic the electronic motion in hydrogen? Other elements can exchange orbital momenta by use of their outer subshell orbitals (LUAOs) but with much less effectiveness and variety than hydrogen. For this reason, hydrogen forms more compounds than any other element. For this reason, hydrogen has the most unique catalytic properties. These reasons further explain the unique ability of hydrogen to assimilate within metallic bonds and the anomalous cold fusion effects (See R B Little). The magnetic moment of the proton and the radical nature of atomic hydrogen allow many possibilities for using external magnetic field to modulate the chemistry and the catalysis by hydrogen. In this new art, R. B. Little reasons and demonstrates that a strong enough magnetic field gives electrons in 1s of hydrogen orbital azimuthal momenta, thereby ordering the electron in the is orbital of hydrogen. Such organization of electrons in a spherical 1s orbitals of hydrogen atoms affects their chemical reactivity and catalysis.

Lithium

Lithium shares some of the characteristics of hydrogen in the use of the s orbital to contribute unique chemical and catalytic properties. As put forth in this new art, (perhaps most notably) lithium's unique reaction with molecular nitrogen reflects the spin and orbital distinctness of the first member of the alkali metals. Unlike other alkali metals, lithium's small size and high charge density lead to its covalency in bonding. The distinct orbital nature of the 2s orbital relative to the 3s, 4s, 5s, 6s and 7s orbitals also contributes to the distinctness of Li chemistry relative to that of the heavier alkali metals. The 2s orbital like the 1s has special character for contributing orbital dynamics but less so than the 1s orbital of the hydrogen atom due to the shielding and core effects of the filled 1s (subshell) on the 2s valence orbital of lithium. In this new art, the 2s valence subshell of Li and its orbital variety is related to its greater reactivity and catalysis relative to heavier alkali metals. This electronic nature of lithium results in the instability and lability of LiOH and Li₂(CO₃) relative to greater the chemical stability of the heavier alkali hydroxides and carbonates. Furthermore these characteristics of lithium result in little kinetic limitations of lithium's reactions, so it explosively reacts with oxygen and water. Lithium readily combines with hydrogen and LiH is stable up to 900° C. Indeed, the unusual s orbital motions in Li and H, what other element can mimic them? Lithium's ability to break N₂ follows from this efficient orbital and spin dynamics of this atom. Hydrogen has even greater orbital and spin dynamics but its bond enthalpy (H—H) is the bottleneck to its breaking N₂. So high temperatures and pressures are needed for H₂ to bond and break N₂. Lithium does so at lower temperatures and pressures. The Haber process requires more harsh transition metal catalytic, temperature and pressure conditions. The Nobel Prize in Chemistry was awarded to Haber for this fixation of atmospheric nitrogen. Perhaps not until now recognized, the special orbital and spin dynamics of lithium's 2s orbital contribute (in addition to electric coulombic factors) to it having the highest reduction potential among metals. The covalency and spin effects and orbital phenomena of lithium's 2s orbital further contribute to organic compounds containing lithium. Like H (but less so), Li has s orbital motion that can readily couple and accept momenta from carbon to assist its rehybridization. The unique orbital and spin dynamics of lithium atoms allow them to be effective catalysts for organic synthesis via organolithium compounds. In this work, external magnetic field is employed to couple with the 2s electron of lithium atoms to modulate the chemistry and catalysis by lithium. External magnetic field can orient the motion of the 2s electron of lithium for novel chemical and catalytic effects.

Beryllium

Just as with lithium, the beryllium atom has a large charge density due to its small size, but the 2s subshell is filled. The filled 2s contributes to more inertness of beryllium relative to lithium. The filled 2s of beryllium results in the need for promotional energy and orbital and spin dynamics to hybridize it, which accounts for the lesser reactivity relative to lithium. The unusual electron affinity of beryllium (one of the few atoms with strange electron affinity) reflects the weak effective nuclear force but also the orbital dynamics of electrons going into its empty p subshell. There are no underlying p subshells to facilitate such order to an electron going into beryllium's empty p subshell! Beryllium is the first element with p orbital motion. Bonding Be requires it developing p orbital motion among its electrons. This acquisition of p orbital motion is a bottleneck to Be chemistry. Beryllium therefore is hesitant in combining with oxygen and water, reacting with oxygen only for temperatures in excess of 200° C. and reacting with water only at red heat. Orbital and spin dynamics restrict beryllium from combining with hydrogen. In this new art, external magnetic fields may lower the temperatures for forming beryllium compounds contributing to greater reactivity of beryllium at less activating conditions.

Boron

Boron introduces an electron in the 2p subshell. Such a configuration of boron results in the easier rehybridizations of 2p and 2s orbitals and the greater reactivity of boron for broader chemical and catalytic effects relative to beryllium. It is quite interesting (and stressed here) that these chemical differences between boron and beryllium can also be considered based on spin and orbital effects of the two atoms. The more ready rehybridization of boron (relative to Be) and its greater nuclear charge contribute to the more extensive covalent chemistry of boron and its greater catalytic effects for a strange array of chemical species with complex bonding and structures unsuspected by the chemical formulas. The more efficient orbital mechanics of boron allow the ease of it coordination and the Lewis acid character of many of its compounds relative to beryllium. The Lewis acid structures and adducts provide important activation intermediates with loose bonding along catalytic reaction routes for unique catalysis by many boron compounds. These orbital effects further account for the ability of boron to form 3 coordinate and 4 coordinate structures for basket like and cage structures. These orbital effects and the weak electro-effects also allow boron to readily release adducts for facilitating catalytic roles.

The electronic structure of boron results in the thermodynamic drive to bond oxygen. Boron (having empty p orbitals) can readily hybridize its 2p with its 2s orbitals. Oxygen having lone electron pairs, allows ready sigma bonding and back bonding between oxygen and boron by 2s and 2p type orbital hybrids. With different hybridizations trigonal BO₃ and tetrahedral BO₄ exist in complex borate structures. The electrostatics and multiple bonding contribute high bond enthalpy and low reactivity of borates. An important aspect of orbital and spin dynamics follows from the protonation of BOₙ units, which is here related to the rehybridization and various transitional transformations of trigonal and tetrahedral structures during oxidation and reduction of borate units. It is important to recall the idea put forth here that hydrogen is special in catalyzing rehybridization. The hydrogenous catalysis of borate transformations is a good example of this unique catalyzing role of hydrogen already mentioned. As put forth in this new art, external magnetization may allow the better controlled synthesis of such complex borate structures. External magnetic field may orient orbital motion of hydrogen for controlling catalytic interactions on borates.

Unlike borates, boranes are extremely reactive, spontaneously flammable in air and readily hydrolyzed by water. As first explained here, the orbital and spin dynamics of the boron and the hydrogen atoms of boranes account for the reactivity of boranes. External magnetization during synthesis and handling of boranes may contribute to unique chemistry and catalysis for boranes. Here it is suggested that the very labile reactivity of boranes results from the efficient spin and orbital dynamics of the atoms in boranes, resulting in boranes being useful reducing agents in organic chemistry and also explaining the important aspects of organoboranes and their roles in organic synthesis. The unique orbital and spin mechanics of boron and hydrogen lead to some very unique compounds in borane chemistry as initiated by Alfred Stock. The boranes may exhibit unique nonconventional bonding as various 2 centered-2 electron bonds and 3 centered 2 electron bonds between boron and hydrogen atoms. According to R. B. Little, in this work the novel orbital mechanics is used to explain the unconventional bonding effects in boranes and some other boron compounds. In particular, in boranes, the B and H cannot develop enough p character in their bonding for substantial directionality. The heavier elements in the second series can develop p character for more directional tetrahedral electron domains, but here boron and hydrogen are insufficient in developing substantial p character internally. These unique orbital mechanics of boron and hydrogen result in important banana type bonding between boron and hydrogen due to the substantial s orbital character in the bond. The larger array of possible reaction scenarios of boranes (ready oxidation to oxides, pyrolysis to higher boranes, attack by nucleophiles and electrophiles, reduction to borane anions) is another clue to the importance and role of orbital and spin mechanics to chemical reactions in general. These orbital aspects of boron and its compounds explain many of their catalytic properties.

This unique aspect of boron and hydrogen is exemplified by the special catalytic nature of tetrahydroborate (BH₄) ⁻ anion in providing orbital momenta for other elemental and compound materials for their ready reduction and hydrogenation. Hydrogen and its catalytic spin and orbital effects can hasten incorporation of carbon into boranes to form carboranes. Boranes are important avenues to carboranes and amineboranes, aminoboranes and borazine. Hydrogen facilitates catalysis of amines, boranes, aminoboranes and borazine also. As consider below, carbon and nitrogen suffer orbital and spin restrictions in forming single bonds, so the borons and hydrogens of boranes facilitate orbital motional requirements for the formation of these B—C and B—N containing compounds. This art introduces external magnetic fields for a new tool to more effectively and controllably form carboranes, borazines, aminoboranes, and amineboranes. External magnetic field may contribute orientation of the electron of the 1s orbital of hydrogen for novel catalytic effects on borane chemistry. It is also important to note the trihalides of boron and their Lewis acidity and their roles in Lewis acid catalysis. Orbital effects of boron contribute to reduce orbital restrictions to kinetics associated with its role as catalysts for reactions involving: 1. ethers and alcohols forming esters, 2. polymerization of alkenes, 3. Freidel Craft alkylation or acylation of benzene. External magnetization may contribute novel effects to all of this interesting chemistry of boron.

Carbon

Perhaps the compounds of carbon have been studied much more than those of any other element. After boron, carbon exhibits increase nuclear charge, more p character and more electrons for completing the second shell covalently through bonding. This leads to the uniqueness of carbon in forming four of the strongest single bonds. Furthermore with carbon unlike boron, the additional electron can contributes to pi bonding options. Carbon, therefore, exists with sigma and pi bonding possibilities. The chemistry of carbon is determined closely by its tendency to sigma and pi bond itself and other elements. The allotropes of carbon reflect these tendencies. Graphite, diamond, fullerenes, carbon nanotubes, and polyynes are examples of how carbon bonds itself giving these structural options. As recorded by R. B. Little, it is important to consider the orbital and spin effects for carbon to express these different types of bonds to itself. Nevertheless when carbon forms these various allotropes, it exhibits great stability. Hydrogen is capable of catalyzing bond breaking of C—C pi and sigma bonds due to its unique electronic motion and interactions as previously considered. As mentioned, strong magnetic field may organize 1s electrons for motion in hydrogen for novel catalytic effects of breaking pi bonds. Hydrogen further is a great starting element to consider in conjunction with carbon as in hydrocarbons. Hydrogen can bind and break up boron and carbon bonds to form boranes and hydrocarbons.

In alkanes, hydrogen forms sigma bonds to sigma bonded carbon. The unique nature of hydrogen (as already considered) facilitates the formation of such compounds. The almost identical electronegativities of carbon and hydrogen (carbon slightly greater) result in the small bond dipole moments in C—H sigma bonds. This very small dipole along with the substantial bond strength contributes to the somewhat inertness of C—H bonds. As put forth here, the low reactivity of alkanes is further heightened by the difficulty of most other elements to buffer the orbital motion needed to rehybridize carbon into different bonded states. On the other hand, the electrostatics and unique motional ability of H to rehybridize carbon causes it to significantly resist motional effects of other elements (other than fluorine) for the catalytically decomposing and reforming alkanes. As a result of these factors, alkanes are somewhat difficult to form and during reactions have a tendency to form unsaturated versions: alkenes and alkynes. The difficult formation of alkanes follows from the difficult formation of diamond in analog with the more kinetic feasible formation of graphite. Indeed, the source of alkanes for the petro-chemical industry lies beneath the surface of the earth just as these internal geological conditions contribute to diamond formation. The internal geological high pressures and temperatures and various catalysts (as in coal gasification) caused in nature and by man's technology contribute to more favorable kinetics for sigma bonding relative to the efficient internal pi bonding option and reaction trajectory as to form alkenes and alkynes. Beneath the earth's surface such conditions prevail. Chemists and engineers have mimicked these conditions in the hydrocarbon reformatory industry. External magnetic field can provide another avenue and a new tool in conjunction with these older arts for limiting pi bonding to form alkanes rather than alkenes.

Inspite of the low reactivity, the reactions of alkanes first involve the substitution of hydrogen by other elements. Organic chemists have employed the most reactive metals and nonmetals for this mission. Nonmetal halogens can replace hydrogen in alkanes to form haloalkanes by free radical mechanisms. Most halogens except fluorine require activation to combine with alkanes. Fluorine attacks alkanes, explosively. External magnetization may slow the kinetics of the radical fluorination processes. The role of radicals in halogenation opens the prospect for the use of external magnetic field as put forth in this new art for influencing such halogenation of alkanes. Such replacement of hydrogen for Cl, Br and I leads to less hinder reactions and bond formation to carbon by other elements. These halogens (having nearly filled p shells) are more readily rehybridized to sp³ internally and intrinsically. As will be considered with fluorine such rehybridization of halogens is more intrinsic and internal. The efficient internal rehybridization of halogens follows from the internal electronic repulsion. Elements left of halogens in the table have less internal intra-atomic electronic repulsion so are less able to internally sp³ rehybridize. Halogens can more readily internally rehybridize to sp³ due to intra-atomic electronic electric and magnetic interactions. Also the halogens are monovalent so via interactions (interatomically), it forces carbon into sp³ bonding. Whereas carbon with its incomplete p subshell has difficulty finding the p orbital motion for rehybridization to the sp³ hybrid state, halogens with their 5p electrons more readily undergo such process to the sp³ state with less needed external interactions. Additionally, carbon lacks electrons in its shell and has available space for electrons, thereby allowing for compatible binding of electron rich halogen atoms. Carbon-halogen bonds therefore lack the heavy electron-electron crowding and repulsion that weaken halogen-halogen bonds. So carbon-halogen bonds are more stable than halogen-halogen bonds. These factors contribute to the ready reactivity of halogens with alkanes. The resulting haloalkanes contain C—X bonds which introduce dipolar centers and greater proclivity to reactions with other elements for introducing different functionalities in carbon chemistry. The halogen bound carbon has greater positive polarity subjecting it to nucleophiles. The proclivity for sp³ orbital motion of halogen contributes more orbital flexibility to the carbon of C—X for reactivity with other elements. The role of halogens in forming bonds to carbon and reactions of carbon have both electrostatic and as the here stressed momental and magnetic factors.

The formation of cycloalkanes is very interesting and a good demonstration of orbital and spin effects during chemical transformations. Cycloalkanes are ring structures of carbons with all sigma bonding in the frame. Cycloalkanes have fewer hydrogens so there formation must compete with pi bonding and alkene or alkyne formations. It has already been noted that hydrogen plays a key role in catalyzing carbon into sp³ bonds so how can sp³ bonds exist in as cycloalkanes, which form under insufficient hydrogen concentrations? Other factors other than hydrogen allow sp³ carbon structures to develop into cyclic compounds without pi bonding. These other factors include high temperature, high pressure, and other nonhydrogenous catalysts. In this work, external magnetic field is put forth as an additional factor for allowing cyclic hydrocarbon formation. The most ready factor contributing to ring formation may be the shortage of hydrogen so that end carbons can find each other. But lack of hydrogen would tend to encourage pi bonding of carbons along the backbone of the molecule. The most ready conditions would have to be higher temperatures and pressures, which would favor more and stronger interactions with carbon atoms for their sp³ hybrid formation for forming C—C bond and sp³ orbital motion so the molecular ends can find each other. Lower temperatures and pressures can lead to cycloalkanes with the assistance of transition metal catalysts. The introduction of cyclic unsaturation is a result of limited hydrogen and conditions to prevent internal pi bonding motion. High pressure contributes more frequent atom-atom interactions for driving electronic rehybridization of sp² carbon to sp³ carbon, thereby countering pi bond formation. In the absence of high pressure, high temperatures can contribute to alkanes forming alkenes due to the lower pressure conditions limiting the sufficient interactions needed to maintain sp³ state and convert the orbital motion from sp² to sp³. Alkanes are therefore converted to alkenes by thermal-pulsed cracking (within fraction of second) at 800-900° C. to form alkene and molecular hydrogen. High temperatures break C—H bonds allowing H₂ formation and the efficient internal C . . . C interactions leading to pi bonding and alkene formation. Catalytic processes can allow lower required temperatures for the reformation of alkanes to cycloalkanes, alkenes and aromatics. In this case, the interactions of carbon with metal atoms provide electro and magneto interactions to break bonds and form new bonds. Furthermore as stressed here, the role of the catalyst facilitates the change in the orbital motions and spins of electrons on carbon. In the case of carbon, such orbital motional dynamics need external assistance, as previously noted, so electronic momental change from sp² carbon to sp³ carbon require intense thermal and/or catalytic conditions.

Examples of these important electrostatic and magneto-motional aspects of rehybridizing carbon atoms include processes associated with the water gas shift reactions:

Coal Gasification
C+H₂O→CO+H₂;
CH₄+O₂+catalyst→CO and H₂
CO+H₂+catalyst→CH₃OH
CH₃OH+CO+catalysts→CH₃COOH

The roles of H, high temperature, high pressure and catalysts in forming sp³ carbon, alkanes and cycloalkanes can be better modulated and controlled when performed in external magnetic field environments. External magnetic field contributes higher concentrations of hydrogen atoms (radicals) for preventing C—C pi bonding. External static magnetic field contributes organized motion of the s electrons of hydrogen and metal catalysts for favorable orchestrated interactions with carbon to lock it into the sp³ hybrid state. As put forth here, the external magnetic field by radical pair effects limits pi bonding.

Whereas alkanes and diamond are difficult to form, the pi bondings for alkene and alkyne formations are ready results of removing hydrogen from alkanes. The pi bonding with the existing sigma bond leads to carbon═carbon double bonding. The pi bond energy is 264 kJ/mol. Whereas sigma bond energy is 377 kJ/mol. Carbon══Carbon double bonding is efficient in the absence of external factors and interactions with easy internal molecular motions and interactions of carbon atoms providing the orbital motion and force for pi bond formation. As noted above, H atom, metal catalysts, halogens, high pressures and (here) external magnetic field are external forces that can prevent pi bonding. Whereas the sp³ hybrid formation requires external interactions and motions, sp² motion follows naturally from efficient synergistic internal dynamics between carbon atoms. The resulting double bond lowers the energy of the carbons for thermodynamic metastability, hence both thermodynamic and kinetics favor alkene formation. It is interesting to note the combined functionality of acidic protons near double bonds and the inherent intrinsic ease of orbital dynamics for both hydrogen shift and methyl shift, tautomerism, aromaticity and resonance on the basis of the efficient orbital mechanics of pi bonds as put forth here. The eventual formation of multiple double bonds in a molecule can lead to aromatic structures. Aromaticity is considered below. The conversion of alkenes to alkanes requires overcoming this tendency to pi bond.

The double bond and its electron rich density provide the functionality for alkenes. It was just previously explained why alkenes and alkynes so readily develop upon stripping hydrocarbons of hydrogen. The resulting kinetics and thermodynamic stability of alkenes cause the resilience of the double bond during its reactions. The double bond most notably contributes reactivity to other regions of the molecule due to its effecting resonance and delocalization of charge. The reaction of this center may also involve the addition across the double bond. Many elements exhibit this addition across the double bond so long as the electrostatics and motional aspects of the reaction are fulfilled. Some atoms require external assistance for addition across C═C. Addition of carbon across the double bond may be facilitates by hydrogen atoms, catalysts or high pressure-high temperature conditions. Other elements like the halogens more readily add across the double bond. The ease of addition across the double bond follows from both electostatics and momental aspects. Hydrogen and halogens readily provide electrostatic and motional factors for addition across the C═C double bond and changing sp² carbons to sp³ carbons. Electrostatically, the electron richness of the reaction center contributes the attraction for electrophillic reagents for electrophillic addition to alkenic reaction center. Examples of electrophiles for alkene addition include hydrogen halides, water, and the additions of halogens via bromonium and chloronium cations. Halogens intrinsically have proclivity toward sp³ motion due to internal 3 lone electron pairs so they efficiently provide motional characteristic for rehybridizing from sp² carbon to sp³ carbon for effective addition across C═C. Halogens are also intrinsically strong electrophiles.

Hydrogen has s orbital motion that can readily soak up and contribute orbital motion for convert sp² carbon to sp³ carbon for effective addition across C═C. Protons can therefore catalyze such additions across the double bond. The catalytic ability of the protons follows from the special nature of protons due to the absence of screening electrons, its spin interactions with its nucleus and the sphericity of s orbital. Protons can break C═C double bonds (special energetics and momenta). Proton can provides the s orbital character for converting p electron to sp³ hybrids. Protons can absorb and exchange p, d, f, g, h ect. orbital momenta. The incipient s orbital momenta via interactions with a proton are unrestricted in motion, having spherical symmetry. Proton can exhibit exotic bonds such as banana type bonds. In this art, it is explained that these properties allow the proton to accommodate orbital and spin mechanics for acid catalyzed addition across the double bond.

Other catalysts like Li, Hg Cu, Ag Pd can also make use (but less so than H) of their nearest s orbital to catalyze addition across double bonds for transforming alkenes. These aspects explain the catalytic tendency of late transition metals for certain reactions like addition across double bonds of alkenes. These catalysts are capable of doing so due to their greater electronegativity for attacking double bond and their available s, d, and p subshells for use in intermediary bonded structures to the double bond reaction center. It is important to note that during these bond rearrangements intermediates form and persist with radical sp² or sp³ carbon. The H atom, halogen, transition metals catalyze breaking pi bonds to form possible radical intermediates and the release of these intermediates to sp³ sigma bonded structures. In this new art, external magnetic field is employed to affect both the catalyst (radical states) and the intermediary carbon species (radical states) during such bond rearrangement and chemical transformation. External magnetic field orients orbital motion for important electronic states involving s orbitals associated with the catalysis. Examples of metal catalysts in converting alkenes to alkanes include the following: 1. reduction of alkenes to alkanes via thermal and catalytic conditions (Pd, 3 atm); 2. in the mercuration reaction, where mercury has access to s, f, d, and p orbitals and it exhibits unique orbital dynamics for catalysis; 3. boron exhibits catalytic activity by availing its empty p orbitals. During hydroboration, the unique structures of boron and its role as catalyst are effective. Having very little p orbital character and motion and a lot of s orbital motion, B (in particular BF₃) can provide pi electrons with more p motion for sp³ hybridization and ready release of sp³ carbon. However boron lacks the great electronegativity to attack alkenes. An external magnetic field forms and affects H and M radicals to coordinate alkenes or alkanes for interconvert. Alkenes can undergo addition reaction that result in polymerization. Magnetic fields can affect such polymerization.

The removal of many protons from hydrocarbons may allow formation of the two pi bonds for triple bonded structures. Alkynes are organic molecules with triple bonds. Alkynes are unique in some respects. Alkynes exhibit acidity of their protons and the tendency to undergo addition. The formation of alkynes follows from efficient internal bonding. The recent experiments on laser vaporization of diamond demonstrate the efficiency of internal orbital processes for pi bonding. In the absence of hydrogen, HPHT, and catalysts, laser vaporization of diamond produces polyynes (a conjugated chain of triply bonded carbon atoms) over graphenes. The highly unsaturated carbon atoms sigma bond and then rapidly pi bond (for sp hybridization), before sufficient C . . . C interactions can lock all carbons into sp³ or sp² bonds. Just as was for alkenes not much static magnetic field is needed for forming alkynes, more static magnetic field is needed to decompose alkynes. Dynamic external magnetic field may drive alkyne formation at higher temperature and under higher pressure conditions. Just as was the cases with alkenes, in order to destroy the triple bond, the conditions must overcome internal interactions and forces as well as provide electronic motion and momenta. Hydrogen, catalytic processes, high temperatures and high pressures are important means of overcoming internal processes to form alkenes and alkanes from alkynes. These conditions provide necessary orbital dynamics for sp carbon states to convert to sp³ carbon. These effects are exemplified in the catalytic addition effects across triple bonds of alkynes.

Addition reactions of alkynes involve both the catalytic hydrogenation and the chemical hydrogenation. During such addition, the importance of orbital and spin dynamics and the role of transition metal catalysts and proton or hydrogen atoms are further demonstrated and outlined in this new art. Hydrogen, alkali metals and transition metals, catalyze addition of hydrogen across alkynes. The s orbitals of atoms in HgSO₄, LiAlH₄ catalyze hydrogenation of alkyne. This catalytic activity of the s orbitals results from efficient exchange of orbital momenta with sp carbon for its conversion to orbital motion of sp³ carbon. External magnetic field can orient s orbital motion in hydrogen and these metal catalysts for novel chemical and catalytic effects. Boron also makes use of its empty p orbital to provide p momenta for catalyzing addition across alkynes. In this boron (BF₃) example, the weak Lewis acidity of p orbitals provides the catalytic route for rehybridization of sp carbon although less readily than the activity associated with hydrogen (Bronsted-Lowery acid). The funny bonding and structures of boron species contribute to addition across C≡C triple bonds as well. The planar structure with three halogen atoms also allows favorable sp motional symmetry and electrostatics for catalyzing the addition across alkynes. Unlike boron, protons have stronger motional and electrostatic effects for catalyzing sp to sp³ hybridization and motional dynamics and bond rearrangement. In general, protons are important for the addition across C≡C triple bonds. HgSO₄—H₂SO₄ catalyzes the hydration of alkynes, via the orbital effects of Hg²⁺ and H⁺ as well as electrophillic effects. The high acidity of alkynes contributes to it being a nucleophilic precursors and subject them to electrophillic attack. Alkynes are subject to electrophillic addition by electrophiles. Bases can catalyze the formation of carbanions from alkynes based on the electric force pulling off ions and the ready internal pi bonding to triple bond.

Compounds containing more than one double bond have very interesting properties. Those involving double bonds on every other pair of carbons (conjugate pi bonds) have even more interesting properties. The electrostatic and orbital aspects of conjugated alkene formation are similar to those of alkene formation, conditions are needed that favor orbital changes from sp³ carbon to sp² carbon. These conjugated alkenes exhibit interactions between the pi bonds, resonance effects, and for some ring structures exhibit aromaticity. The conjugation and resonance lead to electrons of the neighboring pi bonds being delocalized among more than two atoms. The conjugation contributes quantum mechanically distributed, delocalized motion. The conjugation lowers the energy because electrons are associated with more nuclei. Conjugation contributes to electronic motion over larger space and lower frequency orbital motions. The formation of conjugate pi bonds involves changes in orbital motion of s and p electrons. Conditions must be favorable for such orbital momental dynamics. Just as for alkene formation, the conditions may involve high temperatures, slightly moderate pressures and/or catalysts. Now the conditions must favor the removal of two pairs (or more) of neighboring hydrogens and the internal interactions for pi bonding two (or more) pairs of carbon atoms. High temperatures, slight pressures can allow alkanes to loose hydrogen atoms and internally form pi bonds with increased probability of conjugation. External magnetic pulses may assist the formation of conjugated alkenes by momentarily stabilizing broken pi bonds for shifts and resonance to develop conjugated structures.

Perhaps more interesting are the orbital and spin dynamics associated with combinations of two molecules containing conjugated double bonds and double bonds. Such combination reactions are known as Diels-Alder Reactions. These reactions require no catalysts. The conditions lead to an autocatalysis under sufficient pressure and temperature. External magnetic pulses may enhance the Diels and Alder processes. The diene and dienophile combine by addition of the double bond of the dienophile across the conjugated diene. This kind of reaction occurs efficiently at slightly elevated temperatures and pressures. The success of this reaction which earned Diels and Alder the Nobel Prize in Chemistry follows from several factors, which do provide a nice example of the art proposed here of the importance of electronic orbital and spin mechanics during bond rearrangement. The first factor is the intrinsic symmetry of the reactants. The carbon atoms preexist in the proper bond angles and distances for such addition. The second factor involves the overlap of bonding and antibonding orbitals of the diene and dienophile, which weaken existing double and (possibly) triple bonds. These first and second factors determine the proper inherent symmetry. The third factor set forth in this art involves the efficient internal mechanics of pi bonding, which forms three conjugate pi bonds in the transient broken intermediary state. The symmetric consequences of the first two factors allows the intrinsic orbital and spin mechanics of the third factor. The fourth factor involves the lowering of the energy from the aromaticity of the result 6 electron pi ring. The Diels-Alder reaction occurs at above 200° C. and higher pressures. The synergy of these factors result in the process involving no intermediates, so-called pericyclic process.

The product of the Diels-Alders reaction can be the benzene or phenyl ring. The benzene or phenyl functional group consists of a ring of six carbon atoms connected by sigma bonds and three conjugated pi bonds. In this special chemical structure, the conjugation comes back on itself to form a cycle. The orbital motion in such pi conjugated, cyclic, ring structures differs from orbital motion in non-cyclic conjugated pi systems. The different orbital motions lead to different energies of cyclic and noncyclic conjugated planar structures. Electrons in cyclic aromatic rings have lower energies than in their linear counter parts. In the cyclic aromatic structures, the motion involves less charge separation and less drastic momental changes, than in the linear structures, so the potential energy maximum is less during electronic motion in the cyclic aromatic structure. Furthermore, in the cyclic aromatic structures, the structures allow the wavefunction to constructively superpose. Also in the cyclic aromatic the wavefunctions is not changing direction being clockwise or counter-clock wise. In this new art, it is suggested that aromaticity results from cyclic orbital motion of odd numbers of conjugated pi electron pairs. Benzene exists unsaturated, but it is stable due to this orbital motion. Due to the greater stability beyond conjugated chain alkenes, benzene is even more unreactive than conjugated alkenes and alkenes in general. Reaction of benzene's aromatic frame would require delocalized→localized orbital motion or energy input and momenta input. Breaking aromaticity would require strong electrostatic, thermal energies and efficient orbital motional changes. Phenyl rings are therefore not typical of alkenes or alkynes. Phenyl rings have greater stability associated with aromaticity, which involves a lower energy state due to 4n+2 electrons (n=1, 2, 3, . . . ) of conjugate pi bonds in ring planar structure.

It is interesting to consider the efficient pi bonding process as put forth here in this new art with the resonance and aromaticity introduced in this section. Efficient pi bonding, rearrangement and mechanics allow enhanced resonance effect and lead to aromaticity. There is an entropic effect associated with electronic conjugation, resonance and aromaticity. Aromaticity lowers electron-electron repulsion and causes greater interaction of electrons with more nuclei. Here it is suggested that aromaticity occurs when odd numbers of electron pairs have cyclic motions. Under intense thermal conditions, both thermodynamics and kinetics favor phenyl formation. Not much static magnetic field effects may enhance phenyl formation.

Because of the great stability of benzene and other aromatic molecules, they resist reactions that disrupt the aromatic ring motion. Such would involve delocalized aromatic orbital motion converting to more localized internal motion. Such orbital momental changes are not favored and require conservation of momenta. Energetically and momentally, such breaking of aromaticity is not feasible. External static magnetization may disrupt the electron pairing to favor breaking aromaticity. R. B. Little discovered that external static magnetic field in excess of 15 T can disrupt aromatic rings in graphite at temperatures about 900° C. to allow diamond formation. R. B. Little reasoned the destabilizing influence of external static magnetic field on ring currents in adjacent phenyl rings of graphene structures. Such external magnetization raises activation to graphene formation and lowers activation to diamond formation. R. B. Little reasoned the lowering of activation energy to diamond formation based on the increased probability of multi carbon radical interactions and collisions for more likely sp³ hybrid formation.

But now back to aromatic chemistry in nonmagnetic environments, the breaking of aromaticity is kinetically and thermodynamically infeasible. Therefore most reactions of aromatic structures involve electrophillic substitution. Such substitutions preserve the aromaticity. The electrophillic substitution on benzene may involve such electrophiles as: Br and nitrosyl cations. The nitrosyl cations are formed from HNO₃. The formation of O—N—O from HNO₃ involves orbital aspects of O and N chemistry catalyzed by protons and will be consider subsequently. This chemistry of N and O to form nitrosyl cation requires orbital effects that are emphasized in this new art. The resulting nitro group can be catalytically decomposed by Fe⁺ in HCl. The reduction of nitro is caused by Ni²⁺ catalyst or Fe²⁺ in HCl. The s orbitals of protons and the s, p, d orbitals of Fe²⁺ and Ni²⁺ orchestrate orbital changes in N and O for nitrate to transform to the nitrosyl and the H₂O molecule. Benzene may be sulfonated in sulfuric acid media. Similar to transformation of nitrates, sulfates can be more easily transformed in acidic media due to orbital effects of low lying d orbitals of sulfur. N has no low lying d orbitals so transitions metals assist NO₃→O—N—O. Sulfur has its d orbitals so SO₄²⁻ can form SO₃ with less external catalytic assistance. These reactions of decomposition and reduction involve orbital dynamics that are therefore facilitated by protic-acidic solutions. Freidel craft akylation and acylations can form aromatic-alkyl compounds. These examples further exemplify the catalytic role of the proton and its activity of changing electronic orbital motions of N, O, and S atoms in their various functional groups in organic chemistry. In addition, the Lewis acid and proton catalysts can promote substitution on benzene. The Lewis acid forms cations for electrophilic substitutions. The proton also contributes to the substitution reactions.

Although more difficult, the benzene may be oxidized or reduced thereby breaking aromaticity. As previously considered breaking aromaticity would involve strong electrostatic potential energy effects or high thermal energies with efficient orbital dynamics. For example, K₂Cr₂O₇ catalyzes oxidation of benzene. Vanadium oxides also oxide benzene. These chromium and vanadium compounds provide oxidizing and orbital effects for the oxidations. The high oxidation states and the presence of oxygen provide electrostatic effects to oxidize and break aromaticity. Spin effects of Cr and V compounds present bottlenecks to pi bonding back to aromatics, allowing easier oxidations. Transition metals like Pt, Pd, and high pressure can catalyze the reduction of benzene by hydrogen to form alkanes. These catalytic effects reflect the need to provide orbital and spin momenta as well as potential energy effects to lower the activation energy for rehybridizing carbon orbitals from aromatic to sp³. The efficient pi bonding, resonance as given here explains the delocalization of charge and the enhanced acidity of benzyl protons, thereby forming benzyl anion and the phenyl-en tautomerism. As with diamond formation, external magnetic field may provide a new environment for easily oxidizing aromatic structures and for more readily hydrogenating aromatic structures. The static external magnetic field can orient electron motion of hydrogen and catalysts for facilitating catalytic oxidation of aromatic structures. Furthermore, dynamic magnetic environments may facilitate substitution of more harsh electrophiles without breaking the aromaticity.

Alkyl halides can form from alkanes. In these formations, halogens substitute hydrogens on the alkanes. The halides contribute sp³ motion to carbon rather than the s orbital motion contributed by hydrogen. The halogen creates a highly dipolar reaction center for making the carbon slightly cationic in nature. Heavier C—X alkyl halides are more subject to reactivity than C—F due to the weaker bonds and easier rehybridization. Halogens more readily react with alkanes, fluorine does so explosively. F—F bonds are readily broken. The strength of the C—F forming bond causes thermodynamics stability. However relative to other elements, halogens (in particular fluorine) preexist in sp³ hybrid states due to the internal e⁻ . . . e⁻ repulsion from the three pairs of lone electrons. Halogens readily provide sp³ motion to incipient carbon by assisting the rehybridization of carbon to sp³. The scission of X₂ creates radicals that can replace hydrogens of alkanes. Heavier halides need more activation for reaction. Light and/or heat can provide activation energy for halogen scission to form halogen radicals. External magnetic field put forth here may influence these radicals and their reactions and product distribution.

The formation of organometallic compounds (Grignard Reagent) involves magnetics, orbitals and spin effects of the metal atom on the carbon during the bond rearrangement. Alkaline earth metals use full s subshells and empty p subshell to make bonding states with carbon and influence the bonding intermediary carbon during bond rearrangements. The alkyl halides are subject to reactions with organometallic compounds like Grignard reagent and organolithium to form C—C bonds. Actually we may consider this as going about like a catalytic reaction. The Grignard reagent being a somewhat stable intermediate of the catalytic reaction trajectory, causes carbanion character in carbon. The alkyl halide contributes carbocation character to a second carbon for reaction with Grignard reagent to form a carbon-carbon bond. In general, the positive carbon polarity in alkyl halides subjects the carbon to nucleophiles of Grignard reagent. Much chemistry of alkyl halides involves nucleophilic attack. Nucleophiles go into antibonding orbitals of halides and push out halides as leaving groups. In this art, the nucleophilicity may be explained on the basis of efficient orbital dynamics and exchange as well as electrostatic effects. Some nucleophiles may be radicals. Such nucleophiles can be influenced by external magnetic field.

Protons are great nucleophiles for catalyzing nucleophillic substitution reactions and participation in nucleophillic reactions. Protons exhibit electrostatic and momenta effects in this capacity. The proton also presents an environment that prevents pi bonding. Such properties of protons contribute to the categorization of solvents as protic and aprotic on the basis of orbital and spin effects, aside from electrostatic effects. Here the special role of protic solvents involves their motional orbital effects also. The aprotic solvents although lacking this protonic motional effect do possess electrostatic effects as nucleophiles or electrophiles in protic media. External magnetic field may organize electron motion for better proton catalysis. External magnetic field may contribute influence on proton during such reactions. The magnetic field may contribute to the loss of two nucleophiles for enhancing elimination reactions for beta elimination to alkenes. Magnetic field may promote radical formation and heterolytic bond cleavage. Strong magnetic field can stabilize radicals. In this way, magnetic field may control chain initiation, chain propagation and chain termination during radical reactions and polymerization by radical intermediates.

Alcohols are types of organic molecules derived by substituting H on alkanes by OH or more feasibly substituting halogens of alkyl halides for OH⁻ by say nucleophilic aliphatic substitution reactions. The OH⁻ group is not as polar as some halogen groups. But the reaction centers containing the OH⁻ group have special reactive properties. Like fluorine, oxygen of OH is very electronegative and has two lone pairs that facilitate internal processes for orbital rehybridization to sp³ (although not with the same driving tendency as fluorine). Unlike F, oxygen can form two covalent bonds and it is subject to protonation of its lone pair, which contributes to it becoming a better leaving group for bond scission from the carbon center of C—OH. Acid catalyze reactions of alcohols are therefore important. Again external magnetic field may influence acid-catalyzed substitution reactions. The OH group can exhibits acidity so there is more versatility relative to carbon halides. The influence of external magnetic field on these reactions via the proton is of essence in this new art. The hydrogen facilitates bonding of the oxygen to other atoms. Hydrogen disrupts oxygen's tendency to form double bonds. External magnetization as put forth here may contribute hesitance to pi bonding to form C══O and carbonyl formations during the substitution reactions on alcohols. This external magnetization may therefore inhibit aldehyde and ketone formations. On the other hand, a dynamic magnetic field environment may accelerate carbonyl formation in less acidic, oxidizing and/or catalytic media.

The proton and lone pair of OH undergo important magnetics, orbital motional and spins effects during the catalyzed transformations. In general in chemistry, hydrogen bonding is one great example of this. During substitution reactions of alcohols to form halides, acidic protons catalyze the rearrangement of intermediates. This versatility of the C—OH group allows such reactions centers as these to form: R—O—C, R—O—S, and R—O—P groups. This nature of the R—OH and the protons also opens way to the rehybridization of both carbon and oxygen for pi bonding and the carbonyl formation. In this regard, protons and Cr compounds (chromic acid) may catalyze the oxidation of C—OH to aldehydes, ketones and carboxylic acids. The oxidation is catalyzed on the basis that the proton and Cr (in this regard) provide motional aspect by providing available s orbitals for electronic rehybridization of both carbon and oxygen from sp³ to sp². This type of oxidation of alcohols to carbonyls is further afforded by the electrostatics of the strong oxidant: H₂CrO₄.

It is important to contrast differences in p and s characters and orbital motions in alcohols and thiols, due to O being in the second series whereas S being in the third series. Sulfur's sp³ bonds have more p character than oxygen's. Sulfur is less subject to orbital motional restrictions during bond rearrangement relative to oxygen. The Na⁺ ion is able to catalyze thiol formation, there is no need for the strong proton catalyst H⁺ as in alcohol chemistry. Therefore, thiol chemistry involves less needed catalytic assistance relative to alcohol chemistry. Furthermore sulfur and phosphorus have weaker S═S and P═P double bonds than the C═C double bond. The alcohols via proton catalysis allow PBr₃ and SOCl₂ to combine with alcohols to form stable P—O—C and S—O—C bonds and functional groups. Orbital aspects of the surrounding proton media facilitate conversion of alcohols to these various phosphate and sulfate functional derivatives. The acidic media thereby protonates phosphate and sulfate groups, breaking sp² orbital motion for transformation to sp³ orbital motion as phosphate or sulfate anions substitution OH⁻ on alcohols. Again, protic solutions have unique catalytic roles both motionally and electrostatically. In these structures, oxygen is further prevented from double bonding (liking multiple bonds) via S and P, which can use d orbitals to allow intermediates for forming S—O and P—O bonds, which then eliminate protons, hydroxides and/or water to form more stable products. Acids allow the proton catalyzed dehydration of alcohols to alkenes with important orbital changes from sp³ to sp². External magnetic field, as proposed in this new art, may allow these various chemistries of alcohols and thiols under less acidic conditions for more environmentally friendly and green chemistry.

The nucleophillic replacements of X or OH (of C—X or C—OH) by alkoxide groups can form ethers. Sulfides and epoxides can also be formed by such substitution reactions. The ether functional group introduces polarity in the molecule but the structure is aprotic. Ethers are therefore important structures for providing polar aprotic reaction environments. The reactions to form ethers, sulfides and epoxides are proton catalyzed. The proton acts catalytically by weakening a bond of the bound nucleophiles making them better leaving groups. As considered above, protons also contribute to orbital and spin motions to facilitate the momenta dynamics along reaction trajectories during substitution reactions. The nucleophillic leaving group of the reaction center provides electron pairs to the catalytic proton, thereby initiating the dynamics of the nucleophile's ability to leave and the dynamics of the entering nucleophile to more successfully attack. The 1s orbital of the proton can readily accept the electron pair and their orbital motion of the bound leaving group. External magnetic field can modify the electron motion as it goes to proton thereby allowing novel catalytic effects. The proton thereby assists the cleavage of the C—O bond for the ability of the entering group to come in for bond formation to the carbon center. During the Williamson synthesis, alkoxide nucleophiles attack alkyl halides, during such processes the ions provide electro driving force for conversion. During the acid catalyzed dehydration of di-alcohols to form ethers, the proton weakens C—OH bond of the alcohol for less electric driving factor during transforming two alcohols to ether. The protons also lessen tendency to pi bond for alkene side reactions during the dehydration of dialcohols to form ethers. During reactions of ethers, the acids catalyze the cleavage of C—O—C. Just as was the case of alcohol chemistry, protons operate on the oxygen of the ethers so the bond transformation occurs that favor sigma bonds rather than pi bonding. However as will be considered next in carbonyl chemistry, such acidic media in the presence of oxidizing transition metal and O²⁻ can lead to pi bonding and oxidation of the carbon center of alcohols and ethers to carbonyl or carboxyl groups.

A comparison of the ethers with sulfides is useful for further demonstration of orbital and spin effects during chemical transformations. The sulfur does not have the difficulty of oxygen in undergoing nucleophillic substitution. Sulfur is in the third series and it can involve d orbitals and more hybrid states along reaction trajectories for facilitating orbital changes. In addition to possible orbital dynamics involving available low lying d orbitals, sulfur (unlike O of the second series) has an internal p subshell for a template. R. B. Little suggests that core electrons can contribute to chemical reactions by exchanging orbital motion with valence electrons. The core electrons are lower in energy than valence electrons but their motions can have similar symmetry as valence electrons and momenta may be exchanged between core and valence electrons to affect chemical reactions. Traditionally, chemists have for simplicity decoupled valence orbitals from core orbitals in atoms. But here it is suggested by R. B. Little that the electrons in atoms are strongly coupled electrostatically and via exchange. Such strong coupled forces and motions of electrons in an atom increases with atomic number. Just as Fermi electrons in molecular solids and metals are strongly coupled, the electrons within atom and small molecules are even more strongly coupled. This coupled electronic motion allows efficient exchange of orbital motion and patterns of electronic symmetry of valence electrons by underlying core electrons for consequent dynamical reaction effects, involving valence electrons. R. B. Little suggests that such orbital exchange between valence and core electrons accounts for special catalytic ability of transition metals and other heavy elements. Sulfur has an underlying p orbital template. Oxygen does not have an underlying p orbital template. Therefore sulfides (—C—S—C—) do not require as much orbital assistance to form as the ethers, Na⁺ ions are sufficient in providing orbital motion to form sulfides. Protons are not necessary in sulfide formation as in ether formation. Ethers rely more on acid catalysis for their reactions.

The catalytic role of d orbitals (of external catalytic metals in this case rather than internal d of sulfur) to transform sp² hybrid ethylene to sp³ hybrid in epoxides is demonstrated in the synthesis of epoxides. Epoxide can be formed from ethylene and O₂ by the catalytic action of Ag. Epoxide formation from ethylene involves sp² electronic motion changing to sp³ motion on carbon and oxygen atoms. The Ag catalyst makes use of its sdp orbitals to assist the rehybridization of the carbon and oxygen from sp² to sp³ in forming epoxides from O₂ and ethylene. The unrestricted orbital motion of the proton also allows it to catalyze hydrolysis of epoxides as it does with ethers, by breaking the C—O bond and temporarily preventing pi bonding about the intermediary carbon states. The use of external magnetic field may provide more control of proton-catalyzed substitutions to form and transform ethers, epoxides and sulfides. The less restricted electron motion in s orbitals is further demonstrated in crown ethers. The empty s and p orbitals of the alkali cation accept electron motion from lone pairs of O atoms in the crown ether. The s orbital of the alkali cation is not limited in its momenta so it mixes well with the sp³ hybrid motion of the oxygens of the ethers.

Relative to alcohols and ethers, aldehydes and ketones are more oxidized carbon centers, involving the C—O double bond (carbonyl group). The aldehydes have an H and an alkyl group bound to the carbonyl. Ketones have two alkyl groups bound to the carbonyl. The carbonyl is a very important structure in organic chemistry. Carbonyls have large dipoles associated with the functional group. Carbonyls also have a pi bond associated with its functionality. These special characters of carbonyls synergistically follow from the large dipole for electrostatic and the pi bond, which involves efficient internal molecular mechanics. As already considered, the action of protons and oxidants can form aldehydes and ketones from alcohols and ethers. The carbonyl can act as a nucleophile, wherein the electrons of an entering group can go into antibonding of the carbonyl thereby weakening the C—O. The ability of the carbonyl and the entering group to accelerate the electrons into different orbital motion is important. Oxygen tends to form pi bonds and carbon tends to also form pi bond. Oxygen with two lone pairs tends to more easily sp³ hybridize, but with interactions with carbon the pi bonding of O is more feasible. However, the proton of a protic solvent can facilitate such orbital dynamics of the C and O to oppose C and O pi bond to C═O, but to enhance for sp³ hybrid formation for C—O intermediary bonds. When the nucleophile attacks the carbonyl, the protic solvent catalyzes the process by allowing the rehybrization of oxygens and carbons of intermediates from O sp² to O sp³ and from C sp² to C sp³ along the reaction pathways. Here is yet another example of how external magnetic field may influence the orbital and spin dynamics of reactions in the specific case of reactions of carbonyls. External magnetic field may facilitate chemistry about carbonyls. External magnetization may organize the proton's attack on a carbonyl for sp² to sp³ rehybridization of C and O of the carbonyl to form a protonated intermediate, which then undergo substitution about the carbon center by other nucleophiles with the elimination of proton to reform the carbonyl. During such processes, the proton rehybridizes O and the rehybridized sp³ O intermediate stimulates the conversion of sp² C to sp³ carbon. During these reactions, the carbon goes from sp² to sp³ along the reaction trajectory.

Important nucleophiles involved in such substitution chemistry on carbonyls include grignard reagent, organolithium, anionic alkyne, and cyanide ions. In this environment, of the s orbitals of the alkali metal in grignard and/or the alkali metals of organolithium play important roles in the needed orbital dynamics of the carbon and oxygen. The Grignard reagent uses empty s and p orbitals of Mg or Li for electrostatic effects. The s and p orbitals of Li or Mg also provide spin and orbital effects for facilitating the chemistry. The s orbital of Mg or Li acts in analog to the 1s orbital of hydrogen for catalysis. The grignard chemistry is an acid catalyzed reaction. In organolithium, the lithium acts as the proton does to catalyze breaking the double bond of the carbonyl to form intermediates for subsequent nucleophillic attack and subsequent elimination of protons that reforms the carbonyl. In the sodium acetylide nucleophile, the Na⁺ ion provides this catalytic role.

In addition to alkali and some late transition metals, some p block elements may under stringent conditions use low lying d orbitals for spd hybrids that serve catalytic roles. In the Wittig reaction, positive and negative charges exist on adjacent atoms. In the P—C bond (ylide), the phosphorus of this reaction center rehybridizes to use low lying d orbitals to form intermediates for exchanging O of carbonyl for the C (carbanion-like) of ylide. The resulting formation of strong P═O bonds drives this reaction. During this Wittig reaction, the P can internally use empty low lying d orbitals for catalytic activity to reform C and O bonds in analog to external use of d orbitals by some transition metal catalysts. The acid catalyzed additions of water and alcohols to form acetals (ether alcohol) further demonstrate this point. The chemistry associated with the addition of sulfur nucleophiles is a further example. The acid catalyzed addition of thiols to carbonyls is yet another example. The nitrogen nucleophiles can attack carbonyls under acid catalyzing conditions (to avoid N₂) to form imine (Schiff base) demonstrates this effect. In all these examples, electronic orbital motion during bond rearrangement is assisted by low lying d orbitals of nonmetals, proton, alkali s orbital, and/or transition metal sdp orbital effects so as to temporarily break pi bond and then substitute on sp³ intermediary carbon species with subsequent proton catalyzed elimination to reform double bond C═══O of carbonyl.

Other important illustrative examples are ketone-enol tautomerisms. This tautomeric effect is possible because of the efficiency of pi bonding; resonance of pi bonding due to its efficiency and internal proclivity; the large internal dipole moment of C══O; and the role of external protons or internal acidity to modulate pi bond dynamics. Such tautomerism is facilitated by internal electron pairs and internal available protons for internal orbital and spin dynamics of protons between pi bonding options. Tautomerism is a beautiful example of the efficient orbital dynamics of acidic protons and pi bonds as put forth here in this new art. The efficiency of protons to accept electrons of any pre-existing orbital motion and the internal intrinsic rapidity of proximity of orbitals to pi bond (as presented in this new art) explains a lot of chemistry between discrete reactants and in this case of tautomeric internal chemistry when these groups exist within the same molecule. Multifunctional molecule containing OH, ═, ≡, NH and other acidic protons can undergo efficient rapid internal chemistry for tautomerism.

The conversions of aldehydes and ketones to carboxylic acids involve their oxidation with accompanying rehybridization and needed orbital motion. In conditions of acidic media with strong oxidants, the protonated intermediate may undergo further oxidation rather than reform the carbonyl. Chromic acid (H₂CrO₄) is an effective catalyst for such oxidations. The chromic acid facilitates the spin and orbital dynamics of placing an oxygen on the carbon atom of the protonated carbonyl. The magnetics and high spin properties of chromium catalytic intermediates facilitate sp³ hybridizations of C and O, and H restrict the pi bonding of C and O so that sigma bonds can form the COO group. External magnetization may assist the chromic species' catalytic prevention of pi bonding. An external magnetic field may orient orbital electron motion and order spins on chromic catalytic species. The use of catalysts to limit pi bonding is further shown in the catalytic reduction of carbonyl by using Pt, slight pressure and/or high temperature to add hydrogen to carbonyls to form alcohol. In this case the protonated intermediate is reduced by H. The Pt catalyst coordinates the protonated carbonyl preventing it from pi bonding to reform the carbonyl group. During the chemical or metal hydride reduction of carbonyls, protonation prevents pi bonding and rehybridization to sp² hybrid. These hydrides include LiAlH₄ and NaBH₄. As put forth in this art, external magnetic field may assist the needed orbital mechanics via organizing spin and orbital motions to prevent pi bonding for easier chemical and catalytic reductions. The hydrogen via spin and orbital effects allows the carbon to undergo bond rearrangement with Sp orbital motion changing to sp³ orbital motion under the influence of hydrogen from LiAlH₄ or NaBH₄. Transition metals provide orbital and spin effects during the Clemmenson reduction (Zn(Hg) HCl) and alkali and N (sp³→sp) rehybridization provide orbital effects during the Wolff-Kishner reduction (KOH, H₂N—NH₂). In all this chemistry of carbonyls, the proton, alkali metals, and/or transition metal catalysts and couple nonmetal-nonmetal reactions facilitate the rehybridization of carbonyls to form important intermediates for substitution and subsequent elimination or oxidation reactions. An external magnetic field may also influence the breaking and reforming of pi bond in C══O during such reactions.

Carboxylic acids are compounds containing the COOH functional group. The carbon is oxidized beyond that of aldehydes and ketones. The carboxylate group contains carbonyl and hydroxyl groups. The bond dipoles are therefore even greater in carboxylic acids and the oxidation state of carbon even greater relative to carbon centers in alcohols, ethers, aldehydes and ketones. The carboxylic acids are unique in unresolved tautomerism. The oxidation of carbon to carboxylic acids involves electrostatic as well as the here stressed motional factors. These oxidations of alkynes involve the electrostatics of the H₂SO₄ and Hg₂SO₄ acting on C≡C, forming the weak bases HSO₄⁻, which binds the C≡C antibonding orbitals, thereby weakening the triple bond for a tautomeric structure with concurrent proton transfer from the sulfonated C to the other carbon of the double bond intermediate and the tautomeric shift of the double bond from the carbon (C═C) to C═O for a resonant pi bond shift from C═C to C═O bond and the concurrent release of SO₂ and the formation of a carbonyl with an attached OH for the carboxylate derivative. As already mentioned in the prior reaction dynamics, the bond rearrangements involved are facilitated by protons and spd orbitals of Hg²⁺, which absorb orbital momenta associated with sp carbon (of the alkyne) to transform it to sp² carbon and then transform the sp² carbon-sp² carbon intermediate to sp² C bound to sp² O to form the C═O group and C—H for a RCH—COOH group. The presence of oxidants electrostatically and motionally prevent the sp² carbon from reverting back to sp C≡C of the triple bond. In some systems the oxidation to carboxylic acid is undesirable. External magnetic field may resist the pi bonding to facilitate the oxidation. The protons and Hg²⁺ catalyze the process by providing orbital momenta for the rehybridizations associated with such oxidations of C≡C and C═══C structures to carbonyls and carboxylic acids.

These orbital momental effects are also exemplified in the catalytic roles of Pd²⁺, Cu²⁺ for the oxidation of ethylene (Wacker process). These effects are also exemplified in the Monsanto process: CH₃—OH+CO+Rh³⁺+HI, H₂O→CH₃COOH. The reduction of carboxylic acid by catalyzed LiAlH₄ also demonstrates the role of proton and alkali metals for changing the orbital motion during the rehybridization associated with the conversion of a carboxylic acid to alkane. The sp² carbon-sp² oxygen are converted to sp³ C and sp³ O. The proton and alkali metal s orbitals exchange orbital motion of the C and O of the carboxylic acid group for such reductive rehybridization to alkanes. It is useful at this point to compare the chemistry of borates to carboxylates. The boron in borates is more readily oxidized than the carbon in carboxylates. But the borates are less reactive than carboxylates. The carbon of carboxylates is more reactive in this regard due to its greater internal e-e interaction for facilitating bonding options and orbital motion in possible products in particular C═C and C≡C bound products. Just as protons make borates more reactive, here it is shown that protons contribute more lability to carboxylates. The need for protons, alkali and/or transition metal catalysts for the formation and reduction of carboxylates accounts for its stability and serves important clues to biological systems. External magnetic field may facilitate the orbital exchange for the reduction of carbonyl and carboxylic acid. During acid catalyzed conversions to esters, the proton assists the cleavage of the C—O bond. Similar effects of the proton and its buffering orbital motion for bond rearrangement is given by the acid catalyzed formation of acid halides using thionyl chloride; acid catalyzed reactions with PO compounds, SO compounds NO compounds, CO compounds esters; the formation of Amide acyl+amine; the formation of Nitrile (cyano+carbon bond); and the hydrolysis of nitrile by acid catalysts.

The chemistry associated with substitutions on carboxylic acids yields many functional derivatives of carboxylic acids. These include the functional of carboxylic acids: chlorides, anhydrides, esters, amides, and nitrites. Many of the reactions associated with the formation of these functional derivatives involve protic acid catalysis. Indeed the acidity of amides, imides, and sulfonamides leads to proton transfer, and acidity in polar solvents due to the large dipoles. This acidity is very important toward the acid chlorides and water reactions involving the acid catalyzed effects for easier nucleophilic acyl substitution to form carboxylic acids; the proton catalyzed hydrolysis of acid anhydrides to form carboxylic acids; and the proton catalyzed hydrolysis of esters to form carboxylic acids and alcohols. The catalytic activity of the proton (as already considered in other reactions) follows from its ability to exchange orbital momenta and spin momenta with atoms like C, O, N and S in these various structures. In this case the proton binds lone pairs of O, S, and N atoms of associated functional groups. Such protonation is efficient as the proton readily redirects the lone pair into new hybrid sp³ motion and thereby allowing these atoms of these groups to be better leaving groups while at the same time protecting them from pi bonding by rehybridizing back to sp³ motion. The use of external magnetic field provides an external factor for the magnetic field effects and controlling these processes by assisting protons in protecting the pi bond formation in leaving nucleophiles for better leaving ability. During the base catalyzed reactions, the OH⁻ binds antibonding of carbonyl for easing the breaking of C—O double bond. The subsequent loss of proton may exhaust momenta dynamics and options for bond rearrangement back to carbonyl.

Similarly, the hydrolysis of nitrites may involve similar proton dynamics for facilitating bond rehybridization about N (sp→sp²), which then couples the resulting sp² motion to transform sp motion of carbon to sp³ motion for rehybridization about the C of the initial N≡C. The proton catalyzed hydrolysis of nitrites involves the C≡N triple bond and an analogous tautomerism where one of the pi bonds of the nitrile is protonated and the remaining pi bond shifts to from C≡N (involving the nitrile carbon) to the carbon of the nitrile and an alpha carbon to form H₂N—C═C. Just as for other cases considered above during acid catalyzed carboxylate formation, the s orbital of the proton is taking up orbital momenta of the nitrogen (transforming it from sp to sp²), this momenta exchange is then coupled to the C of the nitrile, allowing its orbital transition from sp to sp² motion so as to allow the subsequent switch of the pi bond via the tautomeric mechanism. The remaining C═N pi bond undergoes tautomeric switch with an adjacent alpha carbon driven by the acidic proton of this alpha carbon. Again the spin interactions of the proton with the electrons of the nearby pi bond allow proton spin dynamics to modulate the orbital dynamics.

Other elements may emulate the proton in such orbital and spin dynamics for catalyzing reactions. External magnetic field effects further modify these reactions on the basis of controlling spin and dynamics of catalytic orbital mechanics. The Grignard and organo-lithium reagents make carbon negatively polarized or nucleophillic so the substitution on acyl carbon can occurs to form a C—C bond. During such processes, the reactions resist adding across the C═O double bond. This resistance results from the tendency of carbon, oxygen and nitrogen to pi bond. The C═O of carbonyl is the center for reaction involved in the pathway, but the product contains the facile and stable pi bond resonance. So now the reduction of carbonyl is difficult. Although difficult, reduction can occur catalytically. Catalysts can lower energy for orbital changes for hydrogenating the carbonyl. This reduction is an important example of spin and orbital effects requiring s orbitals and empty p orbitals of Li, Al, H, B, Na atoms in reagents like: LiAlH₄ and NaBH₄. These hydrides assist changing the electronic motion about carbon and nitrogen for reduction of carboxylic acids and their functional derivatives. In this role, the protons of the hydrides behave catalytically for a chemical reduction. R. B. Little notes the proton involved in orbital and spin effects for catalysis.

The keto-enol like tautomerism follows from the efficient pi bonding and the acidity of the proton alpha to carbonyl group. The tautomerism can form enolate anion, which is nucleophillic and can undergo nucleophillic reactions just as other nucleophiles. Lone electron pairs of the double bond with nearby acidic protons as in enamines can also lead to tautomerism and nucleophiles for substitution reactions. In particular, the enamine anion can contribute to condensation reactions. Such condensation reactions can be base catalyzed or acid catalyzed. The base catalyzed condensation is more electrostatic and is associated with pulling charges apart and ion production for subsequent nucleophilic acyl substitution chemistry. The acid catalyst provides more spin and orbital control to lower kinetic restrictions for substitution. External magnetization can affect the rates and selectivity of such reactions. Strong external magnetic field can orient orbital motion of 1s electrons of H or organize electron motion on protons and other catalysts during protonation. These effects of external magnetic field can influence these acid catalyzed reactions. On the basis of the acidity of alpha protons of carbonyls, the acidity is even more for hydrogens alpha to two carbonyls in the same molecule. In enamines, for similar reasons of tautomerism and reasonance, the hydrogen beta to the carbonyl is acidic. Secondary amines can form anions beta to N and form keto-enol like tautomerism. The resulting anions is nucleophilic and can react as nucleophiles.

Amines are compounds containing C—N and N—H bonds. These compounds are important for their basicity and nucleophilicity. The preparation of amines involves the formation of a carbon-nitrogen bond. Such bond formation requires catalyst, due to the tendency of both nitrogen and carbon to pi bond. The fewer lone pair electrons on nitrogen and carbon relative to F and O lead to more difficult sp³ hybridization of N and C. Protons, alkali and late transition metals may remedy rehybridization of N and C. Protons are therefore great catalysts for assisting C—N sigma bond formation. The reaction of ammonia with alkyl halides, under proton catalytic conditions, leads to nucleophillic substitution, but the substitution is not limited to one step. A mix of primary, secondary and tertiary amines can result. The use of azide (N+=N═N) as nucleophile with subsequent LiAlH₄ reduction as catalyst is more capable of limiting the number of carbon added to the N for forming primary amines. The limitation is a result of the lower nucleophilicity after binding just one carbon to the azide. This lower nucleophilicity of the R—N═N=N relative to H₂N—R is a result of the sp² hybridization of the primary azide and resistance of the pi bond to addition due to needed rehybridization. This is more evidence of the intrinsic orbital effects that direct the course of chemical reactions of the second series elements. The lowering of nucleophillicity after binding one carbon to azide is another good example of the import of orbital momenta during chemical reactions. Whereas N—H is able to undergo orbital motions for substitution more than once, the N═N—H is not as able to change its orbital motion for binding more than one carbon. This inability of changing orbital motion by N═N—H is due to sp² hybridization and the resilient, resisting pi bonding. The use of a dynamics external magnetic field may serve to better protect primary amines from further substitution reactions. The dynamic magnetic field can cause C═N double bond which causes weaker nucleophilicity of the N for further substitution.

Reactions between nitrous acid and sodium nitrite in acidic solutions are important and further demonstrate important orbital effects. The nitrous acid and sodium nitrite form nitrosyl cation by acid catalysis, the resulting nitrosyl cation is an electrophile that actually goes into the substitution. Protic environments play important roles in these reactions, the proton catalyzes hydration to form water and unsaturated nitrogen, which then internally pi bonds (very efficiently) to form the nitrosyl cation. Nitrosyl cation react with amine under proton catalyzing conditions to form R—N═N with the resulting —N═N having great leaving group ability by forming through pi bonding (very efficiently) the thermodynamically stable N—N to complete the substitution.

Nitrogen

As with carbon, the tendency of nitrogen is to form pi bonds. This tendency increases across the series until oxygen. Nitrogen also tends to form three strong sigma bonds with select elements. As with carbon, kinetics plays an important role in limiting sigma bonding mechanics of nitrogen. It appears that the single bond strengths weaken across the series from C to F. Such sigma bonded nitrogen compounds are thermodynamically unstable relative to N₂. Due to the greater effective nuclear charge of N relative to Li, Be, B, and C, anionic N³⁻ is of more importance, especially in compounds with electropositive transition metals. Lithium of course is able to break N₂ to form the nitride, which has sufficient lattice energy for stability. These nitrides hydrolyze to ammonia and OH⁻ in the water environment. Water provides the protons (orbital and spin mechanics) that prevent N₂ formation. In general, based on this discourse, the chemistry of nitrogen involves that of forming pi bonds or preventing pi bonds or use of its lone electrons for bonding. Orbital restrictions may involve the need for s character, whereby protons may provide such s character for rehybridizing N to sp³. The tendency to form N₂ due to the efficient pi bonding by facile internal orbital and spin dynamics contributes to the explosive nature of many nitrogenous compounds in their undergoing combination to the triple bond energy of N₂. For these reasons, nitrogen occurs in nature as N₂. The great strength of the triple bond (944 kJ/mol) (and as discussed here the cumbersome orbital and spin effects for decomposing N₂) leads to its inertness. The magnitude of the inertness of N₂ is gauge by only one element Li being able to break it under ambient conditions; by its complexation with only certain transition metals; by nature's use of lightning bolts to break atmospheric nitrogen; by man's use of catalytic, high pressure and temperature (Haber) process to fix it; and by only a special bacteria capable of independently fixing it. In this art, the importance of orbital and spin dynamics is dramatically exemplified in the chemistry of nitrogen. The ability of hydrogen, lithium and certain transition metal to catalyze breaking N₂ has to do with lowering the energy associated with orbital rehybridization of sp N to sp² or sp³ nitrogen in addition to coulombic effects of bond energies. Lithium provides such catalytic effects at ambient. Hydrogen requires higher temperature in order to break the H—H bond. Transition metals can accomplish this in solution or in molten or at solid metal interfaces. The result is the metastability of nitrogen hydride, lithium nitride and transition metal complexes. Alfred Nobel himself determined the metastability of dynamite in such vain. Boron, carbon and oxygen are able to metastabilize nitrogen in pi bonds as sigma and double bonds versus the stable triple bonding to N₂. All these effects have to do with orbital mechanics of H, Li, B, C, O and transition metals and oxygen in stabilizing N from efficient internal explosive pi bonding to N₂. External magnetization may provide an additional art as outlined here for such limiting the N₂ triple bond formation. The synthesis of various nitrogen compound in essence involves environments to prevent explosive N₂ formation. For example, the dissolution of nitrides in water provide protons that catalytically prevent N₂ formation. The oxidation of ammonia forms N₂ and water, except in the presence of Pt or Pt—Rh catalyst which prevent N₂, allowing NO and water formation. Nitrogen oxides are metastable, the oxygen bonds present a orbital kinetic barrier to N₂ formation. Many nitrogen compounds may be more safely synthesized by using the art presented here. The external magnetic field provides oriented orbital motion in H, Li, B, C, O for even better controlling N proclivity to N₂ formation. External magnetic field also provides organizes electron motion in metal catalysts for novel catalysis of N chemistry.

Oxygen

As with carbon and nitrogen, oxygen forms covalent bonds with the tendency to internally pi bond versus forming 2 sigma bonds. Having higher atomic number, oxygen has stronger tendency to form oxide anion. These general aspects of oxygen bonding and chemistry reflect the increased filling of the second electronic shell, the development of greater electronic repulsion, the greater nuclear charge of oxygen, and the greater p character of oxygen in the hybrid orbitals for bonding. The lone pairs on oxygen contribute greater lewis basicity to oxygen relative to C and N. In this role of oxygen as lewis base, the orbital mechanics of a compatible Lewis acid in accepting an electron pair on the oxygen may contribute some here to now unappreciated effects. The oxides of metals tend to be basic, whereas the oxides of nonmetals tend to be acidic. The acidic qualities of nonmetal oxides coincide with the nonmetal oxide species being less able to provide electronic orbital momenta toward coordinating with a prospective acid, as well as the classic electrostatic contribution to the acidity of electrophile. On the other hand, the basic qualities of metal oxides coincide with the metal oxide species being more able to accommodate the orbital momenta of a prospective acid, as well as the classic electrostatic contribution to the basicity as nucleophile. Oxygen in its compounds and during bond rearrangement faces the easier task of pi bonding by efficient internal interactions. The internal efficiency of pi bonding has been exhaustively exemplified in this art for carbon and nitrogen. But the formation of two sigma bonds is more challenging for oxygen, requiring greater external interactions. As with carbon and nitrogen, external magnetics as outlined in this new art provide control of dynamics to select between pi and sigma bonding options during chemistry associated with oxygen centers. Much of these effects give greater clarity to the observed oxidation tendency of oxygen toward substances. In water, oxygen is a fairly good oxidant. It oxidizes Cr²⁺ and Fe²⁺, but it is unable to oxidize some other metal cations. The ready oxidation of Cr²⁺ and Fe²⁺ follows from their s-d orbital hybridization and ready interactions with the of s-p orbitals of oxygen. However other metals may lack available s-d transitions. For these metal cations, Cr²⁺ and Fe²⁺ can catalyze the oxidation by oxygen. These oxidation reactions and Fe²⁺/Cr²⁺ catalyzed oxidation reactions are examples of intrinsic orbital effects in chemistry and are here explained. An external magnetic field may contribute spin effects for accelerating or decelerating such effects.

R. B. Little has demonstrate novel magnetic field dependence on the oxidation of Cu, Cu/Ag, Cu/Be, Cu/Niobium coil conductors in DC magnets at the National High Magnetic Field Laboratory (NHMFL). The magnetic field causes increased erosion and higher the solubility product of these metals. Oxygen in the cooling water accelerates the oxidation of the conducting metal coils and their erosion with lessening of magnet lifetime and performance. These results of R. B. Little account for the findings in Japan that a N₂ blanket over the cooling water reduces coil erosion and increases the performance and lifetime of the magnet. It is quite remarkable that all coils are coated with Ag and the Ag under some conditions exhibits higher solubility than Cu. In low magnetic environments, the Cu has higher solubility than Ag. In fact, the reason toe coils are coated is due to preconceived notions that the Ag would erode slower than bare Cu. These are beautiful examples of orbital and spin mechanical effects modulating chemical reactions. The oxidation of the metal may involve paramagnetic O atom on paramagnetic triplet O₂ molecules, which upon oxidation of the coils forms O₂⁻ or O₂⁻ or O₂²⁻. According to R. B. Little, the oxidation is electron spin dependent and orbital dependent, electron transfer probabilities between O or O₂ and metals depend upon relative spin orientation of electrons on the oxygen and the metal. The electron transfer also depends on the exchange of orbital momenta between the reactants. Cu and Ag can make use of s, d, p hybrids to accommodate the d electron of the metal going to the p orbital of oxygen. But there exist subtle spin effects during electron transfer and oxidation that can differentiate Cu and Ag. A magnetic field environment can discern differences other than electrostatics between the oxidation of Cu and Ag. In particular, if O and metal atoms are spin polarized (as in an external magnetic field), then electron transfer would require a spin flip, which slows the kinetics of oxidation. On the other hand, if the O and M atoms are not spin polarized, then no spin flip is required for electron transfer, redox processes for oxidation of the metal and reduction of the O. So the redox reaction would occur faster. Therefore in the magnetic environment of the magnet coil in operation, the oxidation should be slower than in zero nonmagnetic environments. However data reveal increase coil erosion and high levels of metal ions in coiling water with increase magnetic field. Moreover Ag has higher concentrations than Cu in the cooling water. In zero magnetic field, Ag is less soluble than Cu. So what are the explanations? Well the greater electron transfer and oxidation of the Cu/Ag metals in the magnetic environment is a result of spin-orbit effects of the metals for intersystem crossing to allow spin flip of electron in hybrid s-d-p metal orbitals so it is transferred to p orbital of O and forms a pair of electrons in the p orbital of the oxide anion (O₂²⁻). The difference between Cu and Ag is a result of the masses and atomic numbers. Ag is heavier atom than Cu atoms, so its spin-orbit effect is greater than that of Cu. The O₂ does exist as triplet O₂ in the magnetic field so spin flip intersystem crossing is needed for transfer of electron from the metal to the O₂. O atoms is intrinsically paramagnetic.

Perhaps the best examples of these effects of orbital and spin mechanics of electrons on the chemical properties are given by the difference in reactivity of singlet and triplet dioxygen. The formation of singlet oxygen from a photoexcited sensitizer is another example. Singlet excited state of the sensitizer is exchanged for the triplet state of oxygen leaving the oxygen in a final singlet excited state. Another example is the chemical production of singlet dioxygen by the reaction of H₂O₂ with Cl to yield 2Cl⁻+2H⁺+O₂. The electrostatic stripping of electron (one spin up the other spin down) from the hydrogens to yield Cl⁻ and H⁺, leaves the electrons on the oxygen paired in the HOMO of the dioxygen molecule. Spins will not allow the electrons to unpair and relax into the ground triplet state. The formation of peroxide is a good example. The H and O would form water. But alkali metal provide weaker (than 1s of H⁺) 2s, 3s, 4s orbitals for fixing oxygen into sp³, so two oxides can form from the O₂⁻. In water protons protect the O₂²⁻ for H₂O₂ formation. Protons prevent pi bonding of O₂²⁻ for O₂ gas formation. Lighter alkali metals can fix oxygen into peroxide states. Heavier alkali metals can fix O into superoxide states. Peroxides also exhibit these orbital and spin effects in there chemistries. High pressures high temperature on O₂ and M can form MO₂. The superoxides are powerful oxidants due to the weak O—O bond and the acidity of protons. Weak O—O bonds and acidic hydrogens lead to interesting reactions with organics via radical formation O and organic radical formation R. External magnetics may contribute unique effects for novel chemistry of formation of such oxide, peroxide, and superoxide structures.

Oxygen fluorides are interesting examples of orbital and spin effects in the second series. Oxygen difluoride OF₂. OF₂ is relative unreactive in H₂, CH₄, or CO unless electric arced. But it is explosive in Cl₂, Br₂, and I₂. The difference has to do with d orbitals of Cl₂, Br₂, and 12, which can change the momenta of the electrons of OF₂. Another orbital effect is given by the use of electric arc to for dioxygen difluoride. As usual the electric arc contributes magnetics and electrons that fix oxygen in sp³ for bonding F atoms.

Fluorine

Fluorine is the most chemically reactive of all elements. The reactivity of fluorine has been attributed to the weak F—F bond and the strong bond enthalpy of F to other elements. In this work, the new art further suggests that the orbital motion contributes also to the facile reactions of fluorine. Having 3 lone pairs of electrons, the lone pair repulsions readily contribute to efficient internal hybridization of fluorine as sp³. So fluorine is able to provide sp³ type motion to other atoms as it binds them in covalent bonds. Fluorine readily accelerates electrons of metals into sp³ patterns to form fluoride anion. A great example of this orbital effect of fluorine is in its reactions with oxygen. Fluorine can combine with oxygen to form F—O—F from NaOH solution: F₂(g)+NaOH (aq)→F—O—F The Na and the H prevent pi bonding of oxygen, so O₂ is not liberated. The fluorine readily fixes oxygen into sp³ hybrid rather than sp². Oxygen has a tendency to for sp² hybrid through pi bonding. Use of electric arc allows formation of F—O—O—F. The electric arc provides a different environment that raises F radicals and electrons which prevent O—O from pi bonding before two F can bind it. Use of external magnetic field is an example of how magnetic field effects may modify the chemistry to even eliminate the use of the arc for the process of synthesizing F—O—O—F. The efficient orbital mechanics for forming sp³ in fluorine and its reactions further contribute to fluorines explosive tendency in alkanes. For important fluorinating reactions of alkanes. Fluorine provides orbital patterns for carbon to maintain its sp³ hybridization. The strong reaction kinetics of fluorine follows from both thermodynamic and kinetic factors. These factors contribute to the difficult and dangerous isolation of fluorine. The orbital effects facilitate the efficient reaction kinetics. Use of external magnetic field may allow the slowing of chemical binding of fluorine atoms. This may contribute easier purification and fluorine and more control use of fluorine to bind other sybstances.

Even with these advancements of the older art more development is in order for more massive production of saturated and unsaturated compounds of these second series elements to spur the growing industry. An even greater capability would be the simultaneous or sequential preparation of singly and doubly bonded compounds via an in-situ single pot technique.

This invention makes use of these older systems and other systems as sources of second series elements and metal atoms for magnetically driven activated and optically stimulated chemical interconversions of saturated and unsaturated chemical structures.

### BRIEF SUMMARY OF THE INVENTION

One of the improvements of the present invention is an apparatus for massively producing compounds of second series elements in higher yield, purity, selectivity and efficiency.

Another improvement of the invention is an apparatus for massively producing saturated and unsaturated second series compounds and materials with less effort, expense and cost by making use of readily available electric power from DC magnets and/or superconducting magnetic technology. The new art exploits magnetic fields and photon effects for eliminating the high temperature and pressure conditions of older art with the needy discovered advantage of producing saturated and/or unsaturated compounds of these elements with less effort.

Another improvement of the present invention is its applicability and industry for both saturated and unsaturated second series compounds, create new composite industry with a single pot synthesis. This new art provides magnetic fields and laser photons for use with current catalytic techniques with the enhancement of the ability of these techniques for generating and selecting saturated and unsaturated compounds. The enhancement is a result of the stabilization of energy and uniformly coherent energy provided by the magnetic field and laser photons in comparison to heat and phonons in older art.

Another improvement of the present invention is its inherent capability for in-situ selectivity of saturated and unsaturated second series elements of compounds for various syntheses. Such in-situ selectivity is lacking by older art. Most existing techniques (although limited) cannot select between saturated and unsaturated compounds. The high-energy (beyond U-V) conditions and instability of second series atoms complicates the formations. The rich bonding and vibration characters of second series elements and their compounds complicate the second series elemental chemistry leading to various products. In particular, the magnetic stabilization for control of logic, reasoning, action, manipulation of process variables and feed-back control are feasible due to advantages provided by this new invention.

Additional improvements and other features of the present invention will be put forth in the description which follows and in part will be apparent to those having ordinary skill in the art upon examination of the following or may be learned from the practice of the present invention. The progress and improvements of the present invention may be realized and ascertained as outlined in the appended claims.

On basis of the present invention, the foregoing and other advantages are achieved in part by a new apparatus for producing saturated and unsaturated compounds of second series elements. The apparatus consists of a reaction chamber having at least one heating element, at least one port for introducing second series elemental and metal precursors and background gases or liquids, at least one port for exhaust gases or liquids. The heating element can be any element useful for heating the content of the reaction chamber and the ports can be a gas inlet and outlet. Metal catalyst (atoms, cluster, nanoparticles and/or macroparticles) may be disposed in the reaction chamber. At least one laser radiation source may be disposed to the reaction chamber for rapidly exciting, heating, intersystem crossing and relaxing second series material and metal atoms. At least one magnetic field generator may be affecting the content of the reaction chamber for magnetic stabilization and densification of various radicals spin states. At least one device for affecting the internal pressure of the reaction chamber is involved. At least one laser IR heating source is arranged within the reaction chamber for selectively heating the metal catalysts. The thermal energy, catalyst, laser fields, magnetic fields, and IR heating facilitate the catalytic conversion of second series material to specific saturated and unsaturated chemical states and structures.

In accordance with the current inventive apparatus, an IR heater is positioned near the reaction chamber that is capable of selectively interacting and heating the catalyst. The IR advantageously allows the rapid selective input of heat to the catalysts for more efficient driving second series elemental species (targets) to absorption, diffusion, rehybridization, spin flipping, interconversion and condensation processes.

In accordance with the current inventive apparatus, a laser for heating the catalyst is focused on the substrate, flowing catalyst and/or bed of catalyst. The laser provides intense energy for driving target and metal catalysts excitation, rehybridization, spin dynamics and chemical conversion.

In accordance with the current inventive apparatus, a magnetic generator is positioned about the reaction chamber that is capable of generating sufficient magnetic fields (static and/or dynamic) for confining the high density of high spin target species produced by the heating element, catalyst and laser-IR energy. The magnetic field may be of sufficient intensity to create, stabilize, drive intersystem crossing and rehybridize important high spin hybridized electronic states of target species. The magnetic densification facilitates the proximity for collisional chemical conversion to various saturated and unsaturated products. The magnetic field may be inclusive of neutron scattering by polarized and unpolarized neutrons.

Embodiments of the present invention include an apparatus comprising a reactive chamber, an IR source, a catalyst source (catalytic conversion), a target precursor source, a heating device, a pressure device, a exciting and/or stimulating laser, a magnetic field generator. The IR beam from the source is energetically tuned and focused so as to be contacted with the metal catalyst atoms to selectively heat the catalyst raising its temperature relative to the surrounding. The magnetic field is tuned dynamically or statically to sufficient intensity to affect the electronic states of target and metal species.

The nature of the catalyst disposed to the reaction chamber comprises any transition metal and/or transition metal compound. Although allowed the catalyst may not be necessary due to the new influence of the neutrons for target electronic rehybridization, spin flipping and fixation.

Another aspect of the current invention is a new method of manufacturing singly and/or multiply bonded products of the targets. The method involves contacting a target containing precursor and possibly a metal containing precursor with an IR source for selectively heating the metal; applying magnetic fields to form, control and concentrate the reaction media, thereby facilitating rehybridization and spin dynamics of metal and target species with better product formation. The application of laser oscillating field to heat the generated high spin target species about useful intermediary excited states may enhance the desired rehybridization and spin dynamics for specific products. All of these applications hereby listed enhance the selective formation of saturated and unsaturated chemical structures of second series elements for the massive production of large saturated products and bulk amounts of unsaturated products.

The inventive method advantageously, selectively produces saturated and unsaturated target compounds without the need for further purification thereby minimizing the loss due to purification processes. By IR, lasing and magnetic interactions, the product is not chemically subject to adulteration during the fabrication, the yield and selectivity are also improved with lower energy input reducing the contamination, undesireds, pollutant generation and cost. This magnetic and IR enhanced formation of saturated and unsaturated compounds may allow the intentional mixing of various products.

Embodiments of the current invention comprise forming second series materials by contacting target atoms and metal atoms with a magnetic field at elevated temperature (e.g. from 100° C. to 1000° C.) and pressures of 0.001 to 100,000 atm with external laser and IR irradiation for enhanced catalytic rehybridization, spin dynamics and densification that is aided by applying magnetic fields of at least 1-500 tesla.

Another aspect of the present invention is a method of using magnetic field for the selective production of saturated and unsaturated compounds, the method facilitates the insitu single pot synthesis of multifunctional saturated and unsaturated products and hybrid saturate/unsaturated products.

Other aspects of the present invention are the production of various second series compounds, e.g. NH₃, singlet oxygen, borates, borides, oxygen fluorides, oxoxynates, fluoroxynates, oxoargonates, fluoro arganates, diamond and CNT. Embodiments include where the articles comprise over 95% second series materials with significant reduction of impurities.

Additional improvements of the present invention will become readily apparent to those skilled in this art from the following detailed description wherein embodiments of the present invention are described simply by way of illustrated of the best mode contemplated for carrying out the present invention. As will be realize, the present invention is capable of other and different embodiments, its several details are capable of modifications in various respects, all without departing from the present invention. Accordingly, the drawing and descriptions are to be regarded as illustrative in nature and not restrictive.

### DESCRIPTION OF THE INVENTION

The current invention focuses and resolves various issues associated with the production rate, yield and selectivity of saturated and unsaturated compounds of second series elements by providing a novel efficient, selective and massive synthetic technique by using intense static and dynamics magnetic fields with IR and laser heating to enhance the dynamics of the catalytic target excitation, rehybridization, spin flipping, diffusion and condensation during single and multiple bonded product formations. The present invention contemplates a novel technique to selectively, efficiently and rapidly enhance the electronic spin and rehybridization dynamics for the fixation of target atoms (and possibly metal atoms) during the formation of these compounds of the second series elements by various the catalytic techniques. The invention is simple in its design. It is however very effective in its use, overcoming the difficulties associated with electronic spin and rehybridization dynamics of target species, the implications from the instability of these intermediate target species and the dynamics of electronic relaxation, regeneration and chemical combination, decomposition and reformation associated with these states. The consequences of better production rate and selectivity with little required muscle outweigh the high electric current and/or cooling requirements associated with the magnetic equipment of the invention. The present invention advantageously reduces or completely eliminates the need for harsh thermal and/or catalytic conditions for necessary target rehybridization, spin, and fixation dynamics that are conducive to single, double and triple bond formations. For saturated structures, the current invention provides high concentrations of high spin target species by magnetic densification via intense static magnetic fields of several teslas, thereby eliminating high-pressure requirements of older arts for single bonded structural formation. Such lower thermal requirements result in lower production expenses. In addition, the present invention by IR and laser heating provides efficient excited target atoms for catalyzed intersystem crossing of excited electrons of target atoms, thereby eliminating high temperature collisional conditions for such high spin production in plasma techniques. Moreover, the use of intense magnetic field and simply changing the nature of the field allow insitu simultaneous or sequential formations of saturated and unsaturated compounds within the same system. This invention discovers the use of magnetic energy for material and compound syntheses, in particular the production of extremely important multi-functional compounds. Furthermore, the present invention advantageously enhances the production rate and selective to levels commensurate with large-scale industrial use.

In an embodiment of the current invention, the heating provides a mechanism for increasing the kinetic energy of target and metal species. The resistance heating provides a controlled thermal atmosphere for saturated and unsaturated formations. The IR heating allows selective heating of the catalysts to higher temperatures for single and multiple bond formations. The target heating in lower ambient environments via the selective heating with IR radiation results in less poisoning of the catalyst, less side products and multiple bond formation under much lower temperatures.

In accordance with the current invention, second series articles are formed by contacting target-containing precursors and metal containing precursors with an intense magnetic field. The field may be static for single bond formation or dynamic for multiple bond formation. During the formation of the second series compounds, a heating element is used to maintain the temperature of the targets. Although the heating element is necessary it is important to note that in this invention the necessary temperature (<100° C.<T<1000° C.) is significantly less than the temperature in the older arts (i.e. Plasma T>3000° C. and CVD T>700° C.). Heating is also accomplished via laser and IR devices. During the formation of the second series compounds, a metal catalyst (atoms, cluster, nanoparticles or bulk) may be supplied to facilitate the formation of the second series compounds. During the formation of the second series compounds, a laser may be used to rapidly heat, excite, and intersystem cross the sample for causing the needed chemical decomposition, absorption, diffusion, rehybridization, spin dynamics and condensation processes associated with single and multiple bond interconversions. The lasing may be synchronized with the magnetization of the catalyst and depositing target. The IR and laser heating and the magnetization causes, promotes, stabilizes, intersystem corsses and condenses triplett, quartet and pentet high spin target states for more efficient bond rearrangement. During the formation of the second series materials, magnetic fields may be applied to the cavity in the reaction chamber to assist confinement of high spin target atoms within and about the catalyst. During the formation of second series materials the pressure is controlled so as to assist chemical condensation. Higher pressure favors single bond formation. In part the type of second series compound formed depends on the conditions of temperature; catalyst; pressure; IR energy; laser energy and intensity; magnetic field strength; and inverted target electronic states.

The single and multiple bonded compounds formed in accordance with the present invention can take the form of molecules, ionic substances fiber, fibril, filament, film, particles, bulk or solid.

The apparatus for the production of compounds of saturated and unsaturated second series elements of the present invention includes a reaction chamber having at least one heating element, catalysts, pressure regulating device, external lasers, and external magnetic field generator. In operation, target and metal containing precursors (second series elemental compound, metal compound and/or second series element-metal target) are introduced into the reaction chamber via precursors for catalytic conversion with the application of heat by laser and IR irradiations for electronic excitation and inversion of target species with an external magnetic field. Under these conditions, it is believed that the target and metal aspecies form radicals. It is believed that contacting the resulting target and metal species with the magnetic field, lasers and catalyst facilitates (under lower temperature CVD conditions) the electronic spin transitions and rehybridization of the electrons of excited target and metal species on the basis of efficient magnetic-spin interactions between the external field and interactions between the metal and target electrons for the enhanced fixation of the excited target via metal species for high spin target states that lead to conversion among various singly and multiply bonded substances. It is believed that the resulting triplett, quartet and pentet high spin target species from the intersystem crossing may be externally stabilized and stimulated by the external intense magnetic field under catalytic conditions for greater probable high-spin, hybrid target states undergoing chemical conversion so as to selectively form singly and multiply bonded substances. It is believed that the external pressure and magnetic field confine the target and metal atoms within the catalysts in ways to allow chemical condensation of the second series articles.

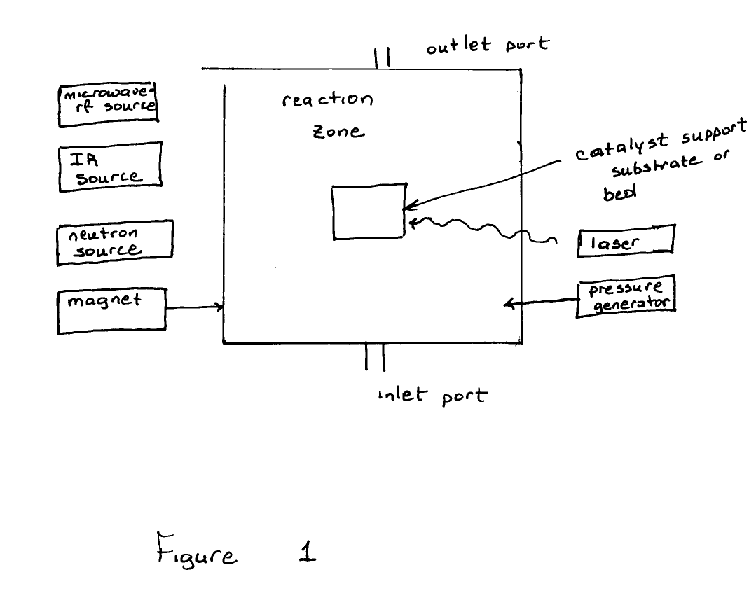

The inventive apparatus can take the physical form in a variety of parts and the arrangement of these parts. In FIG. 1, an apparatus according to the form of the current invention is illustrated. As shown in FIG. 1, the apparatus includes a reaction chamber and at least one laser, at least one heat element, e.g. the combination of the reaction chamber and heating element may be commercially available. The reaction chamber may be equipped with resistance heater, IR heater and heating laser and inlet port for supplying target precursors, an outlet port and an encapsulating solenoidal magnet. The reaction chamber may be equipped with target gaseous precursors flowing to contact a catalyst as with catalytic technology. The heating element and catalytic technologies may be of any design so long as it provides a sufficient thermal source of target and metal atoms. The reaction chamber may be connected to some technology for applying pressure. The reaction chamber includes at least one port for introducing the reactants and at least one port for exit of materials.

In the form of the present invention the reaction chamber is in the fluid communication with the target and metal sources within or without the reaction chamber or with flowing target and metal precursors supplied by inlet ports. The target and metal sources include but are not limited to catalytic conversion. In the form of the current invention, the target and metal species flow is controlled by catalytic rate ect . . . . In practice, the target and metal precursors may be diluted with a background gases such as hydrogen, helium or argon or other reagent gases that are currently known to promote second series elemental compound formation.

In an embodiment of the current art, the reaction chamber provides a space/time for the combination, rearrangement and decomposition of target precursors under the influence of the heating and catalyst particles in the magnetic environment; the electronic rehybridization and spin dynamics of the resulting target species of functional groups; the diffusion of target species about catalysts; and the chemical interconversion of the target species into saturated and/or unsaturated compounds. The heating and magnetization allow the activated targets and metals to be electronically excited, electronically spin polarized, electronically inverted about various hybrid states by lasers, electronically confined by external fields and pressure for the driven chemical interconversion of saturated and unsaturated second series articles under lower temperature and pressure conditions relative to older arts. The reaction chamber should be large enough to allow the internal laser heating and excitation. The reaction chamber should be shaped and sized so as to facilitate catalytic activity under laser, IR and magnetization. The reaction chamber should be of such to allow heating and pressurizing so as to facilitate electronic processes and subsequent chemical interconversion. The reaction chamber should be of the form for sufficient residence of target and metal species for efficient contact with the spin activating magnetic field and the heating laser and IR sources for the formation and stabilization of desirable triplett, quartet and pentet target intermediary states. The reaction chamber should facilitate the intervention of external magnetic fields so as to confine paramagnetic high spin target species within the reaction regions for chemical interconversion between saturated and unsaturated substances.

The reaction chamber also includes at least one additional port, e.g. exit port for exhaust, flue gases and liquids or to attach a pressure device in communication with the reaction chamber, e.g. vacuum pump to reduce pressure or to increase pressure. In accordance with the current inventive apparatus, a catalyst or metal may be disposed to the reaction chamber in the form of transition metal precursor compound or as a seed element in the targets precursors. The catalyst may be metal atom, cluster nanoparticle or bulk particles that are freely dispersed or confined to a substrate.

In an embodiment of the present invention, the catalyst provides of necessary a basis for chemically catalyzing target spin and rehybridization dynamics. The catalyst may be in the form of atoms, clusters, nanoparticle or macroparticles. The catalyst may be transition metal or transition metal compounds. The catalyst may be localized on substrate or uniformly disposed to the reaction zone. The temperature is fine tuned to maximize the influence of the catalyst. The magnetic field is fine tuned to maximize the influence of the catalyst. The laser heating is fine tuned to maximize the influence of the catalyst. The pressure is fine tuned to maximize the influence of the catalyst. The IR is fine tuned to maximize the influence of the catalyst.

In accordance with the current inventive apparatus at least one internal set-up may exist within the reaction chamber for laser irradiation for rapid heating and excitation. In the case of catalytic systems, at least one device may be present to laser irradiate the catalytic metal nanoparticles during their magnetization. An external laser may pump the target and metal atoms to create photon assisted production and stabilization of high spin electronic states of target for enhanced singly and multiply bonds structural interconversion. Any device capable of inverting the target and or metal species is suitable for the present inventive apparatus. These devices include rf and microwave sources that affect spin dynamics The strength of the lasing should be so as to affect significant number of target species and possibly metal species.

In accordance with the present inventive apparatus, at least one device or source of an IR is externally irradiating the substrate surface and/or catalyst bed for selective heating of the metal catalysts. The IR is positioned outside the reaction chamber. Any device capable of the generation of a source of IR radiation can be used in the present inventive apparatus. The IR source may be continuous or pulsed also diffuse or focused. The energy of the IR is such to selectively affect the metal atoms so as to allow chemical, magnetic and electronic processes associated with singly and multiply bond interconversion of the target species. In an embodiment of the current invention, the IR irradiation provides a mechanism for selectively heating the metal instantaneously for decompositions, absorption, rehybridization, spin dynamics and interconversion among suitable hybrid microstates of target species. The IR pulse duration and or energy may be adjusted to be compatibility with the confining magnetic field. The IR pulse duration and/or energy may be adjusted to optimize selective, massive chemical interconversion of saturated and/or unsaturated compounds of second series compounds. The IR flux, pulse duration and or energy may be adjusted to analyze, manipulate and control the selective mass chemical interconversion of saturated and unsaturated compounds.

In accordance with the present inventive apparatus, at least one device for generating magnetic field is placed near the reaction chamber. The device is placed external to the reaction chamber, attached on the outer surface or at a distance from the chamber. Any device capable of generating a magnetic field is suitable for this purpose. The source of magnetic field includes subatomic particles such as polarized and unpolarized neutrons

In an embodiment of the present invention, the magnetic field provides a means for creating, stabilizing, controlling and interconverting, quartet, pentet, hexet, heptet target and metal species within the laser cavity. Various devices may generate the magnetic field. The magnetic field intensity, direction and duration may be so as to maximize confinement, population inversion, rehybridization and chemical interconverison of target species. The magnetic field intensity, duration and direction may be synchronized with IR irradiation so as to confine generate tripplett, quartet, pentet, hexet, heptet target and metal excited species. The magnetic field may be adjusted with regard to heat. The magnetic field may be adjusted with regard to pressure. The magnetic field may be adjusted with regard to exciting lasers so as to control spin and orbital transitions. The magnetic field may be adjusted with regard to catalyst.

The inventive apparatus described by way of the above embodiment can be used to mass-produce second series compounds, such as ammonia, hydrocarbons, singlet oxygen, borates and borides for commercial, industrial and research applications. The various features and advantages of the present invention will become more apparent and facilitated by a description of its operation. As described above, the present inventive apparatus includes a chamber having a heating element, target and metal source, lasers, IR source, internal laser cavity, and an external magnetic field generator.

Target precursors suitable for use in the practice of the present invention are compounds containing target atoms; ie . . . hydrocarbons, borates, borides, nitrates, amines, oxides. Nonlimiting examples of such hydrocarbon compounds includes aromatic hydrocarbons, e.g. benzene, toluene . . . nonaromatic e.g. methane, ethane, . . . and oxygen containing e.g. alcohols, ketones and aldehydes. Sources of species include targets and electrodes, fullerenes and graphite targets.

Metal precursors suitable for use in the practice of the present invention are transition metals and compounds of transition metals. Also alloys of transition metals.

The catalyst need not by in active form before entry into the chamber so long as it can be readily activated under reaction conditions.

In practicing the present invention, second series compounds are formed in the chamber by producing target and metal species from catalytic systems and other sources. Heating the target and metal mixture provides some kinetic energy to facilitate events for subsequent chemical interconversion. Modulating the pressure in the reaction chamber also facilitates collisional events for favorable chemical interconversion. Interactions between target and metal species allow some rehybridization and spin dynamics of target species for suitable chemical interconversion. Contacting target species (and maybe metal atoms for indirect influence on carbon atoms) with an external magnetic field super-enhances the rehybridization and spin dynamics of target species directly (via direct magnetization of target) and indirectly (via magnetization of metal and then metal target rehybridization and spin dynamics). The magnetization and less so the metal rehybridization and spin dynamics of target species result in triplett, quartet and pentet electronic states of the targets. The production of these high spin target states is synchronized with the magnetic confinement by external field. The magnetic field captures high spin species and confines within the reaction region. The laser excitation assists populationally inverts high spin target species about important excited, high-spin, hybrid target states for diffusion, absorption and interconversion for the selective chemical interconversion of singly and multiply bonded products. The laser also causes spin transitions to allow chemical bonding to products.

Reaction parameters include to the particular precursors; catalyst; precursor temperature; catalyst temperature; reaction pressure; residence time; feed composition, including presence and concentration of any diluents (e.g. Ar) or compounds capable of reaction with target to produce gaseous and liquid products (e.g. CO, H₂, H₂O); IR energy, spin polarity, flux and direction; laser pump energy; laser cavity; oscillator conditions; external magnetic field strength and direction. It is contemplated that the reaction parameters are highly interdependent and that the appropriate combination of the reaction parameters will depend on the precursor, catalyst, IR, laser cavity, heating, pressure and magnetic field for the article intended to be fabricated.

In practicing the present invention, the second series elemental compounds containing single and/or multiple bonds can be produced by providing target and metal species source; elevating the temperature to sufficient range tho less than in older art; contacting the target species and metal species at the elevated temperatures; controlling the pressure so as to selectively interconvert specific singly and/or doubly bonded products at lowest pressure. The single bonded products are favored at lower pressures in strong static magnetic fields. Whereas multiple bonds in products are favored in dynamic magnetic environments. The irradiation with IR provides appropriate energy so as to facilitate electronic excitation. The contact of the target with transition metals in the presence of static or dynamic magnetic fields provides conditions for triplett, quartet and pentet target high spin formation, stabilization and interconversion. The laser exciting the target and metal atoms facilitates the electronic rehybridization and spin dynamics. The strong magnetic field also levitates target species for chemical interconversion. With the levitatation the process may be optimized for the efficient growth of second series articles in the magnetic field by changing process parameters T, concentration, electric field, magnetic field pressure, laser irradiation, IR irradiation, oscillation frequency so as to maximize specific target states and condensation of specific products i.e. saturated and unsaturated; and allowing these activities for an effective amount of time. By an effective amount of time it is meant for that amount of time needed to produce mass quantities. The amount of time may be from hours to days depending on conditions.

The target concentration should be high enough to allow the catalyst, IR, heat, laser energy, magnetic field and electric field and pressure to selectively condense saturated and unsaturated products. The precise concentration will depend on the desired product.

The metal catalyst concentration should be high enough to allow the target, IR, heat, laser energy, magnetic field, and pressure to selectively condense singly and multiply bonded products. The precise metal concentration will depend on the desired product. IR and lasing allow lower metal and possibly no metal for gaseous and liquid products. More metal yield solid products.

The temperature should be high enough to allow the target, catalyst, IR, laser energy, magnetic field, and pressure to selectively condense saturated and unsaturated products. The precise temperature will depend on the desired product. The IR and laser may allow higher temperature without the need to use catalyst. Higher temperature and pressure may be bad due to collisional rehybridization and spin flipping. IR and laser may allow lower temperature collisions may not be factors because target species is hard to rehybridize and spin flip low density of states.

The laser exciting should be at a wavelength that facilitates the rapid absorption and electronic transitions of the target and metal species for efficient electronic, chemical, transport and interconversion processes leading to saturated and unsaturated formation. The wavelength, intensity, pulse width and duration are process variables that are fine tuned to the desired product saturated and unsaturated products.

The IR irradiation should be so as to facilitate the activation energy for electronic, chemical, transport and interconversion of species to form triplett, quartet and pentet high spin target states for chemical interconversion of saturated and unsaturated saturated and unsaturated in lower temperature ambient environments. This growth in lower temperature ambient provides advantageous possibilities. The lower ambient temperature results in less excess energy for fewer side reactions and products.

The pressure device should be in communication with the reaction chamber and adjustable for high pressure to vacuum so as to facilitate.

The magnetic field is used to create, stabilize and concentrate high spin target and metal species. The magnetic field may separate high spin from low spin species, providing high density of high spin target species for singly bonded saturated products at pressures much less than older art. On the other hand, dynamic field provides conditions for unsaturated multiply bonded product formation.

It is contemplated that the chamber housing the target and metal atoms be maintained so that the heat, pressure, exciting laser, IR, and magnetic field can influence these target and metal species. The heat (temperature) and pressure of the target and metal species are maintained below a certain range so as to reduce collisional rehybridization of target species for selective singly and multiply bonded products.

In an embodiment of the present invention, saturated and unsaturated products can be produced by passing target and metal species through the apparatus having pressure, temperature, IR source, heating laser, and magnetic field that stimulate product formation. It is believed that by this process saturated and unsaturated product may grow (chemically form) in the reaction zone.

The present apparatus allows the formation of saturated and unsaturated products without much impurity. The much larger growth rate relative to older allows kinetically entrained doping of impurity. This new art produces high spin target species at such high concentrations for rapid kinetically restricted chemical interconversion and for possible controllable mixing of saturated and unsaturated product species. The magnetic field suspends target species actively as they grow.

In accordance with an embodiment of the present invention the final compounds of second series elements may be removed, separated from the metal.

### EXAMPLE

An apparatus was built by aligning the catalyst bed in a quartz tube within the furnace with a magnetic field source at National High Magnetic Field Laboratory. The catalyst was made by forming Fe/Mo nanoparticles from Fe/Mo cluster molecules. The Fe/Mo in the nanoparticles was roughly 1-2 nm. The catalyst was placed on a silicon substrate to form the catalyst bed. The catalyst bed was placed within the quartz tube having a length of 8 ft and diameter of 25 mm. The catalyst bed was arranged at a location of the quartz tube, where the tube wall was flattened (to form irradiation window) to facilitate the in-situ laser and IR irradiation of the interior. The quartz tube with the inserted catalyst bed was then located within the a specially designed furnace which contained two sets of diametrically aligned holes in the furnace walls at about halfway along its length. The hole pairs in the furnace walls define a line that intersect the axis of the tube furnace. The holes in the furnace allow irradiation and in-situ observation of the catalyst within the quartz tube as the furnace heats the quartz and catalyst for saturated and unsaturated product formation. One hole pair is for IR irradiation. The other hole pair is for laser irradiation. The furnace was heated in the range of 100° C. to 1000° C. after the pressure in the tube was adjusted and a flowing atmosphere of Ar was established. After 10 minutes of Ar purging, Ar flow was stopped and hydrogen flow was started. After 10 minutes of purging with hydrogen, simultaneously precursor was introduced into the quartz tube and magnetic field from the superconducting magnet was directed onto the catalysts on the substrate. A laser beam and IR radiation were focused on the catalyst bed during the magnetization. For this particular example, the IRs and laser beams were focused on the catalyst during catalytic conversion. The IR are deep penetrating and permeate the catalytic NP affecting both the electrons of absorbed target species and the metal lattice. These IR, magnet-electron interactions enhance electronic spin transitions of target species that promote target species interaction with the catalyst and chemical precipitation as saturated and unsaturated products. The laser in this example drives specific plasmons in the NP and phonons that facilitate target species motion and electron interactions with neutrons for enhanced saturated and unsaturated product interconversion.

Saturated and/or unsaturated products were made by contacting precursor with the catalyst while irradiating with magnetization and IR and laser photons. Subsequent characterization of the singly and multiply bonded products revealed high purity and faster growth rate relative to the production in the absence of IR and laser irradiation.

The present invention provides enabling art for the fabrication saturated and unsaturated second series articles with improved yield, purity, selectivity and efficiency.

What is claimed:

1. A process for production of compounds of second series elements said process comprising:
i. Contacting catalyst with precursor containing Li, Be, B, C, N, O, and/or F in a reaction zone, while holding the reaction zone at conditions suitable for chemical conversion of precursor to various products, and applying an external magnetic field in order to accelerate, enhance and select hybrid states of bonding of (Li, Be, B, C, N, O, F) in the product,
ii. Changing the intensity and/or direction of the magnetic field relative to the catalyst.

2. A process for the production of various compounds of second series elements according to claim 1, wherein the catalysts are located on a substrate, in a catalyst bed or flow in with reactants.

3. A process for the production of various compounds of second series elements according to claim 2, wherein the substrate is located on a sample holder in the reaction zone, a catalyst bed or a movable reaction zone and the step of changing the intensity and/or direction of the magnetic field is accomplished by rotating and/or translating the holder, the bed or the reaction chamber.

4. A process for production of compounds of second series elements said process comprising:
i. contacting catalyst with a suitable precursor in a reaction zone, while holding the reaction zone at conditions suitable for chemical transformation to desired products and applying an external magnetic field,
ii. changing the strength of the magnetic field during the chemical transformation.

5. A process for production of compounds of second series elements said process comprising:
i. Contacting the catalyst with suitable precursor in a reaction zone, while holding the reaction zone at conditions suitable for the chemical transformation to form desired products, and applying an external magnetic field.
ii. Changing the direction of the magnetic field during the chemical transformation.
